(19) United States
(12) Patent Application Publication
(10) Pub. No.: US 2024/0305335 A1
(43) Pub. Date: Sep. 12, 2024

(54) FREQUENCY DEPENDENT CONTROLLING AND IMPULSE RESPONSE FILTERING FOR A RECONFIGURABLE INTELLIGENT SURFACE (RIS)

(71) Applicant: QUALCOMM INCORPORATED, San Diego, CA (US)

(72) Inventors: Ahmed Elshafie, San Diego, CA (US); Yu Zhang, San Diego, CA (US); Hwan Joon Kwon, San Diego, CA (US); Krishna Kiran Mukkavilli, San Diego, CA (US)

(21) Appl. No.: 18/547,592

(22) PCT Filed: Apr. 9, 2021
(86) PCT No.: PCT/CN2021/086144

§ 371 Date: Aug. 23, 2023

(51) Int. Cl. H04B 7/04; H01Q 15/00

(52) U.S. Cl. CPC H04B 7/04013; H01Q 15/0013

(57) ABSTRACT

Aspects of the disclosure relate to a reconfigurable intelligent surface (RIS) controller for controlling a RIS panel to be frequency and/or element dependent, and for operating an adaptive filtering function. The RIS controller may be configured to transmit, to a scheduling entity, a RIS frequency capability indication for indicating communication support of the RIS panel for one or more frequency ranges. The scheduling entity, then, may transmit RIS control information based on the RIS frequency capability indication. In response, the RIS controller may receive the RIS control information and configure the RIS panel based on the RIS control information. Other aspects, embodiments, and features are also claimed and described.

### TECHNICAL FIELD

The technology discussed below relates generally to wireless communication systems, and more particularly, to a reconfigurable intelligent surface (RIS).

### INTRODUCTION

Recently, reconfigurable intelligent surface (RIS) technologies have been introduced to enhance system throughput and enlarge cell coverage with low hardware cost and low power consumption. As a relaying technology, a RIS may extend the coverage area of a cell by redirecting impinging signals on the RIS panel to given directions. As the demand for mobile broadband access continues to increase, research and development continue to advance wireless communication technologies not only to meet the growing demand for mobile broadband access including several frequency bands, but to advance and enhance the user experience with mobile communications even with user's mobility.

### BRIEF SUMMARY OF SOME EXAMPLES

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In various aspects, the disclosure generally relates to controlling a reconfigurable intelligent surface (RIS) panel. In some scenarios, a RIS controller may configure the RIS panel to change the phase and/or amplitude of an incident signal on the RIS panel. In some examples, the RIS controller may control the phase and/or amplitude of an incident signal to be dependent on one or more RIS elements of the RIS panel and/or to be dependent on one or more frequency ranges. In some examples, the RIS controller may configure the RIS panel for adapting to time-varying channel characteristics.

In some aspects of the disclosure, a RIS controller coupled to a RIS panel may transmit a RIS frequency capability indication for indicating communication support of the RIS panel for one or more frequency ranges. The RIS controller may further receive RIS control information based on the frequency capability indication. The RIS controller, then, may configure the RIS panel based on the RIS control information.

In some aspects of the disclosure, a scheduling entity may receive, from a RIS controller, a RIS frequency capability indication for indicating communication support of a RIS panel for one or more frequency ranges. The scheduling entity may transmit, to the RIS controller, RIS control information based on the RIS frequency capability indication for configuring the RIS panel based on the RIS control information.

These and other aspects of the technology discussed herein will become more fully understood upon a review of the detailed description, which follows. Other aspects, features, and embodiments will become apparent to those of ordinary skill in the art, upon reviewing the following description of specific, exemplary embodiments in conjunction with the accompanying figures. While the following description may discuss various advantages and features relative to certain embodiments and figures, all embodiments can include one or more of the advantageous features discussed herein. In other words, while this description may discuss one or more embodiments as having certain advantageous features, one or more of such features may also be used in accordance with the various embodiments discussed herein. In similar fashion, while this description may discuss exemplary embodiments as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some embodiments.

FIG. 2 is a conceptual illustration of an example of a radio access network according to some embodiments.

FIG. 3 is a block diagram illustrating a wireless communication system supporting multiple-input multiple-output (MIMO) communication according to some embodiments.

FIGS. 4A and 4B are conceptual illustrations of examples of reconfigurable intelligent surface (RIS) communication according to some embodiments.

FIG. 5 is a schematic illustration of exemplary channel estimation using a RIS according to some embodiments.

FIGS. 6A-6C are conceptual illustrations of examples of frequency-dependent and/or element-dependent RIS communication according to some embodiments.

FIG. 7 is a block diagram conceptually illustrating an example of a frequency and/or element dependent RIS according to some embodiments.

FIG. 8 is a conceptual illustration of an example of a RIS for adapt to any time-varying channel characteristics according to some embodiments.

FIG. 9 is a block diagram conceptually illustrating an example of a hardware implementation for a scheduling entity according to some embodiments.

FIG. 10 is a block diagram conceptually illustrating an example of a hardware implementation for a scheduled entity according to some embodiments.

FIG. 11 is a flow chart illustrating an exemplary process for RIS communication for one or more RIS operating frequency ranges according to some embodiments.

FIG. 12 is a flow chart illustrating an exemplary process for RIS communication for capturing mobility of a scheduled entity according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

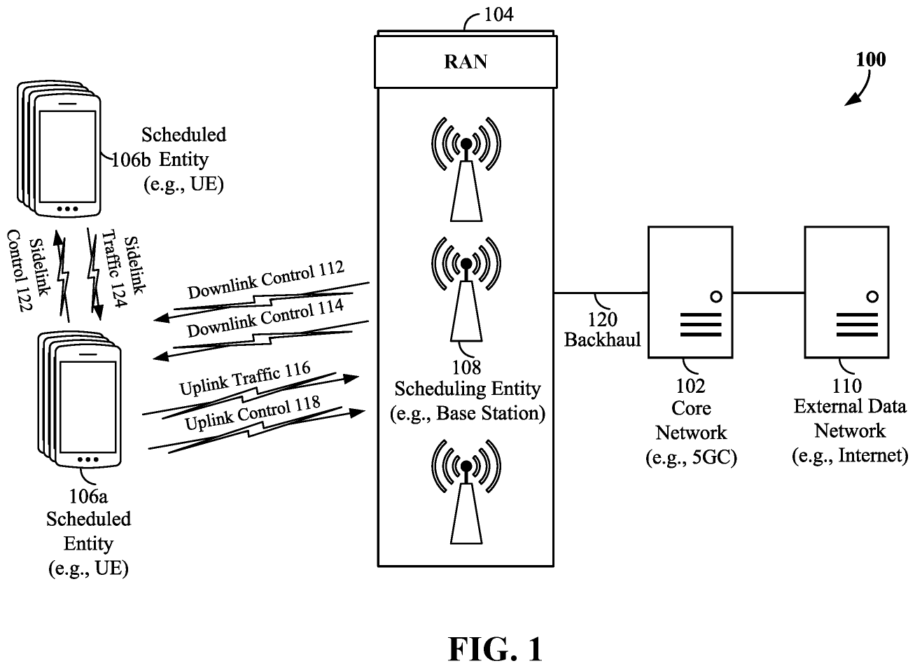

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106a. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106a. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, those skilled in the art may variously refer to a base station as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 supports wireless communication for multiple mobile apparatuses. Those skilled in the art may refer to a mobile apparatus as user equipment (UE) in 3GPP standards, but may also be refer to a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device: a logistics controller: agricultural equipment: military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below: e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

In some examples, scheduled entities such as a first scheduled entity 106a and a second scheduled entity 106b may utilize sidelink signals for direct D2D communication. Sidelink signals may include sidelink traffic 124 and sidelink control 122. Sidelink control information 122 may in some examples include a request signal, such as a request-to-send (RTS), a source transmit signal (STS), and/or a direction selection signal (DSS). The request signal may provide for a scheduled entity 106a to request a duration of time to keep a sidelink channel available for a sidelink signal. Sidelink control information 122 may further include a response signal, such as a clear-to-send (CTS) and/or a destination receive signal (DRS). The response signal may provide for the scheduled entity 106b to indicate the availability of the sidelink channel, e.g., for a requested duration of time. An exchange of request and response signals (e.g., handshake) may enable different scheduled entities 106b performing sidelink communications to negotiate the availability of the sidelink channel prior to communication of the sidelink traffic information 124.

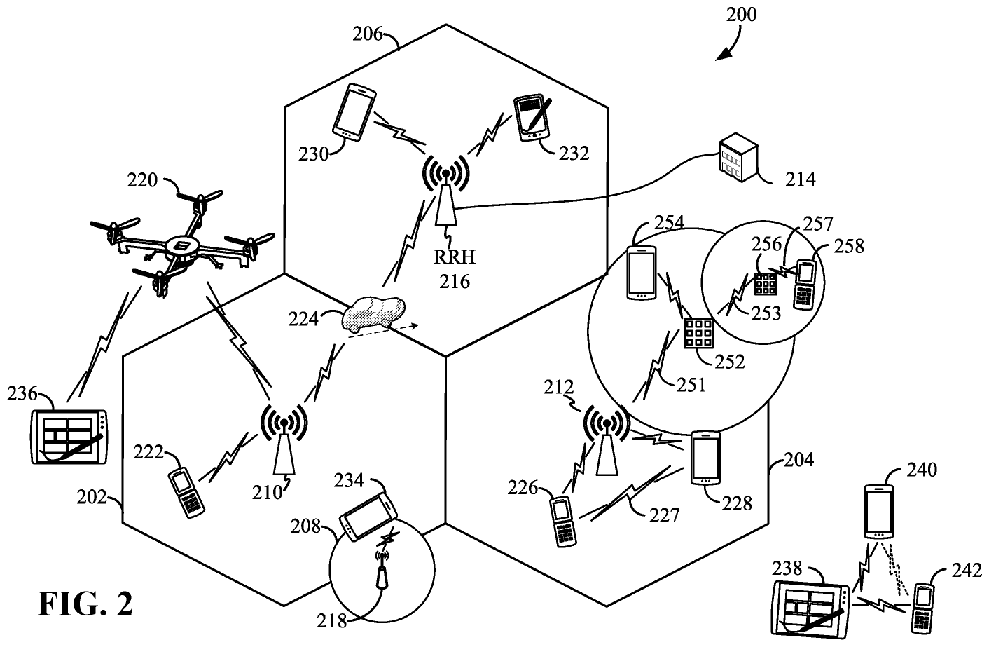

FIG. 2 provides a schematic illustration of a RAN 200, by way of example and without limitation. In some examples, the RAN 200 may be the same as the RAN 104 described above and illustrated in FIG. 1. The geographic area covered by the RAN 200 may be divided into cellular regions (cells) that a user equipment (UE) can uniquely identify based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

FIG. 2 shows two base stations 210 and 212 in cells 202 and 204; and shows a third base station 214 controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

The RAN 200 may include any number of wireless base stations and cells. Further, a RAN may include a relay node to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

In FIG. 2, a reconfigurable intelligent surface (RIS) 252 may be deployed to extend the size or coverage area of a given cell. The RIS 252 may be within the cell 204 of the base station 212. The base station 212 may transmit signals to the RIS 252 through a forward link 251. Then, the RIS 252 may redirect the signals to a UE 254 or another RIS 256 through an access link 253. While the RIS 252 may access the UE 254 and another RIS 256, the UE 254 and another RIS 256 may not be within the cell 204 of the base station 212. The access link 253 between the RIS 252 and another RIS 256 may be a forward link 253 to another RIS 256. Another RIS 256 may receive the signals from the RIS 252 through the forward link 253 and redirect the signals to a different UE 258 through the access link 257. Similarly, although another RIS 256 may access the UE 258, the base station 212 or the RIS 252 may not access the UE 258 because the UE 258 may not be within the coverage area that the base station 212 or the RIS 252 can serve.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

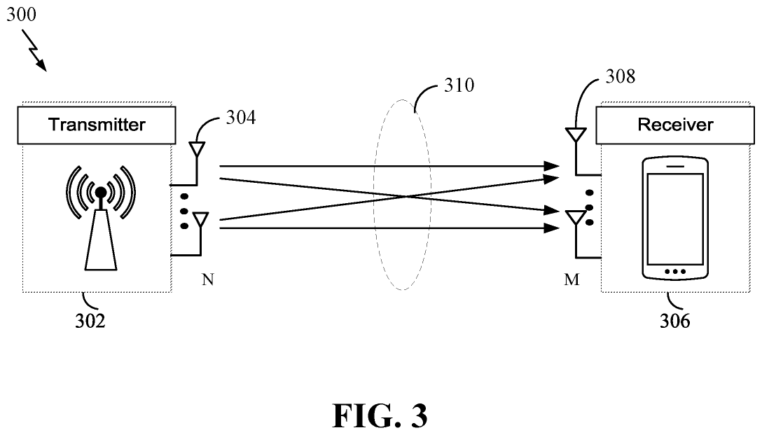

In some aspects of the disclosure, the scheduling entity and/or scheduled entity may be configured with multiple antennas for beamforming and/or multiple-input multiple-output (MIMO) technology. FIG. 3 illustrates an example of a wireless communication system 300 with multiple antennas, supporting beamforming and/or MIMO. The use of such multiple antenna technology enables the wireless communication system to exploit the spatial domain to support spatial multiplexing, beamforming, and transmit diversity.

Beamforming generally refers to directional signal transmission or reception. For a beamformed transmission, a transmitting device may precode, or control the amplitude and phase of each antenna in an array of antennas to create a desired (e.g., directional) pattern of constructive and destructive interference in the wavefront. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

In a MIMO system, spatial multiplexing may be used to transmit multiple different streams of data, also referred to as layers, simultaneously on the same time-frequency resource. In some examples, a transmitter 302 may send multiple data streams to a single receiver. In this way, a MIMO system takes advantage of capacity gains and/or increased data rates associated with using multiple antennas in rich scattering environments where channel variations can be tracked. Here, the receiver 306 may track these channel variations and provide corresponding feedback to the transmitter 302. In the simplest case, as shown in FIG. 3, a rank-2 (i.e., including 2 data streams) spatial multiplexing transmission on a 2×2 MIMO antenna configuration will transmit two data streams via two transmit antennas 304. The signal from each transmit antenna 304 reaches each receive antenna 308 along a different signal path 310. The receiver 306 may then reconstruct the data streams using the received signals from each receive antenna 308.

In some examples, a transmitter may send multiple data streams to multiple receivers. This is generally referred to as multi-user MIMO (MU-MIMO). In this way, a MU-MIMO system exploits multipath signal propagation to increase the overall network capacity by increasing throughput and spectral efficiency, and reducing the required transmission energy. This is achieved by a transmitter 302 spatially precoding (i.e., multiplying the data streams with different weighting and phase shifting) each data stream (in some examples, based on known channel state information) and then transmitting each spatially precoded stream through multiple transmit antennas to the receiving devices using the same allocated time-frequency resources. A receiver (e.g., receiver 306) may transmit feedback including a quantized version of the channel so that the transmitter 302 can schedule the receivers with good channel separation. The spatially precoded data streams arrive at the receivers with different spatial signatures, which enables the receiver(s) (in some examples, in combination with known channel state information) to separate these streams from one another and recover the data streams destined for that receiver. In the other direction, multiple transmitters can each transmit a spatially precoded data stream to a single receiver, which enables the receiver to identify the source of each spatially precoded data stream.

The number of data streams or layers in a MIMO or MU-MIMO (generally referred to as MIMO) system corresponds to the rank of the transmission. In general, the rank of a MIMO system is limited by the number of transmit or receive antennas 304 or 308, whichever is lower. In addition, the channel conditions at the receiver 306, as well as other considerations, such as the available resources at the transmitter 302, may also affect the transmission rank. For example, a base station in a RAN (e.g., transmitter 302) may assign a rank (and therefore, a number of data streams) for a DL transmission to a particular UE (e.g., receiver 306) based on a rank indicator (RI) the UE transmits to the base station. The UE may determine this RI based on the antenna configuration (e.g., the number of transmit and receive antennas) and a measured signal-to-interference-and-noise ratio (SINR) on each of the receive antennas. The RI may indicate, for example, the number of layers that the UE may support under the current channel conditions. The base station may use the RI along with resource information (e.g., the available resources and amount of data to be scheduled for the UE) to assign a DL transmission rank to the UE.

The transmitter 302 determines the precoding of the transmitted data stream or streams based, e.g., on known channel state information of the channel on which the transmitter 302 transmits the data stream(s). For example, the transmitter 302 may transmit one or more suitable reference signals (e.g., a channel state information reference signal, or CSI-RS) that the receiver 306 may measure. The receiver 306 may then report measured channel quality information (CQI) back to the transmitter 302. This CQI generally reports the current communication channel quality, and in some examples, a requested transport block size (TBS) for future transmissions to the receiver. In some examples, the receiver 306 may further report a precoding matrix indicator (PMI) to the transmitter 302. This PMI generally reports the receiver's 306 preferred precoding matrix for the transmitter 302 to use, and may be indexed to a predefined codebook. The transmitter 302 may then utilize this CQI/PMI to determine a suitable precoding matrix for transmissions to the receiver 306.

In Time Division Duplex (TDD) systems, the UL and DL may be reciprocal, in that each uses different time slots of the same frequency bandwidth. Therefore, in TDD systems, a transmitter 302 may assign a rank for DL MIMO transmissions based on an UL SINR measurement (e.g., based on a sounding reference signal (SRS) or other pilot signal transmitted from the receiver 306). Based on the assigned rank, the transmitter 302 may then transmit a channel state information reference signal (CSI-RS) with separate sequences for each layer to provide for multi-layer channel estimation. From the CSI-RS, the receiver 306 may measure the channel quality across layers and resource blocks. The receiver 306 may then transmit a CSI report (including, e.g., CQI, RI, and PMI) to the transmitter 302 for use in updating the rank and assigning resources for future DL transmissions.

### Reconfigurable Intelligent Surface

In 5G NR, massive multiple-input multiple-output (MIMO) plays an important role in increasing throughput. In some examples, active antenna units (AAUs) may achieve the benefits of massive MIMO with high beamforming gain. The AAU may contain active electronic components like antenna-integrated radio designs such that the AAU may actively increase the received signal strength and increase the end-user throughput. In the AAUs, each antenna port may have an individual radio frequency transceiver chain. However, due to their active electronic components, the AAUs may result in a significant increase in power consumption.

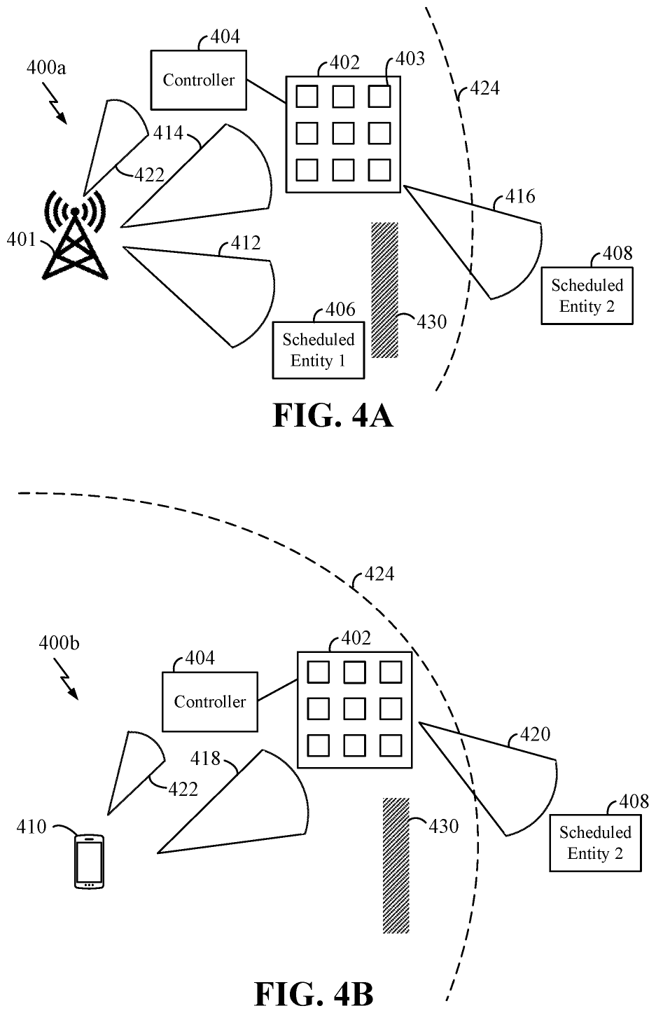

Therefore, in some other examples, to reduce power consumption and extend communication coverage at the same time, a reconfigurable intelligent surface (RIS) 402 shown in FIGS. 4A and 4B, also called intelligent reflecting surface (IRS), large intelligent surface (LIS), or software-controlled metasurface, may be used. A RIS panel or a RIS surface 402 may be, for example, a surface of electromagnetic (EM) material, which can be reconfigurable or electronically controllable with integrated electronics. The RIS panel 402 may include a two-dimensional array of discrete RIS elements or RIS reflective elements 403. A RIS controller 404 coupled to the RIS panel 402 may control the RIS elements individually or on a group level to redirect an impinging signal 414, 418 on the RIS elements 403 of the surface 402 to a given direction 416, 420. In addition, the RIS controller 404 may control the RIS panel 402 to differently modify the properties of signals on different frequency ranges.

The RIS panel 402 may modify the properties of the signal 414, 418 and redirect the signal 416, 420 to a scheduled entity 408. In some examples, software may control and modify with time the properties, including absorption, reflection, refraction, and/or diffraction, of the surface 402. Thus, a RIS panel 402 can change, e.g., the phase, amplitude, frequency, and polarization of the impinging signals 414, 418 and redirect the impinging signals 414, 418 to given directions 416, 420. In some examples, a scheduling entity 401, 410 may control the reflection direction and/or other properties of impinging signals 414, 418 on the surface 402 through the RIS controller 404 coupled to the RIS panel 402. Further, since software in the RIS controller 404 may program and control the RIS panel 402, the RIS panel 402 can be adaptive, e.g., configurable and reconfigurable, after its deployment.

In addition, a RIS 402 may be a nearly passive device because the surface of the RIS 402 might not require any transmit radio-frequency (RF) chains to redirect impinging signals. Due to its relatively low power consumption, the RIS 402 might not require complex signal processing due to its software-defined surface. However, it should be appreciated that the RIS panel 402 is not limited to a nearly passive device. In some examples, a RIS panel 402 may change the amplitude of an impinging signal and/or generate new radio waves based on the impinging signal. Besides, the RIS 402 may operate in full-duplex mode.

FIGS. 4A and 4B illustrate some examples of how a RIS 402 can expand communication coverage and create additional propagation paths. A scheduling entity 401, 410 may support a coverage area 424 in which a scheduled entity 406 can communicate with the scheduling entity 401, 410 based on a signal broadcasted from the scheduling entity 401, 410. The scheduling entity 401, 410 may be a base station, a monitoring UE for sidelink, or any other suitable node which can transmit and receive a signal to other nodes. Here, the scheduled entity 406 may be a user equipment (UE), another RIS, or any other suitable node to communicate with the scheduling entity 401. For example, as shown in FIG. 4A, if the scheduled entity 1 (406) is within the cell 424 without any blockage 430 between the base station 401 and the scheduled entity 1 (406), the scheduled entity 1 (406) may directly communicate with the base station 401. However, some scheduled entities 408 may not be capable of accessing the base station 401 because a blockage 430 exists between the scheduled entity 408 and the base station 401, or the scheduled entity 408 is not within the cell coverage area 424 in which the scheduled entity 408 can communicate with the base station 401.

A RIS 402 as a relaying technology may extend the size and/or coverage area of the cell 424. The RIS 402 may be within the cell 424 of the base station 401, and may redirect signals from the base station 401 to nodes that are not within the coverage area of the cell 424 or are not able to access the base station 401 for any suitable reasons. In some examples, e.g., as shown in FIG. 4A, the base station 401 may not directly communicate with a scheduled entity 2 (408) due to the blockage 430, its out-of-coverage location from the base station 401, or any other suitable reason to prevent communication with the base station. However, the base station 401 may communicate with the scheduled entity 2 (408) through the RIS 402. For example, the base station 401 may transmit a signal to the RIS panel 402. The RIS panel 402 may receive the signal and redirect the signal to the scheduled entity 2 (408) such that the RIS panel 402 shifts the phase and/or the properties of the signal and redirects the signal to the scheduled entity 2 (408). In addition, the RIS panel 402 may transmit the signal 414 to other nodes at the same time. The base station 401 may also communicate with the RIS controller 404 to configure a set of RIS elements of the RIS panel 402 including the whole RIS elements of the RIS 402 to redirect a signal 414 from the base station 401 to the scheduled entity 2 (408).

In other examples as shown in FIG. 4B, the RIS 402 may be in use for sidelink communication. For example, although a monitoring UE (410) may not directly communicate with a scheduled entity 2 (408) for any suitable reasons, the monitoring UE (410) may communicate with the scheduled entity 2 (408) through the RIS panel 402. The monitoring UE (410) may transmit a signal 418 to the RIS panel 402. The RIS panel 402 may receive the signal 418 and redirect the signal 420 to the scheduled entity 2 (408). The monitoring UE (410) may also communicate with the RIS controller 404 to configure the RIS 402 to redirect a signal 418 from the monitoring UE (410) to the scheduled entity (408).

A RIS controller 404 may control the RIS panel 402 for the redirection of a signal to a given direction. In some examples, the RIS controller 404 may be coupled to the RIS 402. The coupling may be physical such that the RIS controller 404 may be physically connected to the RIS 402. That is, a wire or cable may connect the RIS controller 404 to the RIS 402. In other examples, the RIS controller 404 may be attached to the RIS 402 as part of the RIS 402. However, it should be appreciated that the coupling between the RIS controller 404 and the RIS 402 may not be limited to material connections. For example, the connection may be a wireless-based connection via a radio frequency signal using the current state of the art.

In some examples, before commencing communication between the scheduling entity 401, 410 and the scheduled entity 408 through the RIS 402, the RIS controller 404 may communicate with the scheduling entity 401, 410 to configure the RIS panel. In order to commence communication between the scheduling entity 401, 410 and the RIS controller 404, the RIS controller 404 may be in connection with the scheduling entity 401, 410. To be connected, the RIS controller 404 and the scheduling entity 401, 410 may perform an initial handshake procedure. Through the initial message exchange between the scheduling entity 401, 410 and the RIS controller 404, the RIS controller 404 may implicitly inform, to the scheduling entity 401, 410, a controller frequency capability indication, which indicates communication support for the RIS controller 404 with the scheduling entity 401, 410 on a given frequency range. However, it should be appreciated that the RIS controller 404 may explicitly transmit the controller frequency capability indication in a separate message to the scheduling entity 401, 410. In some examples, the RIS controller 404 may transmit the controller frequency capability indication via a radio resource control (RRC) message. This message may indicate the communication support for the RIS controller 404 with the scheduling entity 401, 410 on one or more operating frequency ranges. When a frequency range in use may not be usable anymore for any suitable reason, the scheduling entity 401, 410 may use another operating frequency range of the one or more operating frequency ranges notified in the separate message. For example, the RIS controller 404 may transmit, to the scheduling entity 401, 410, a controller frequency capability indication in a separate message for indicating communication support of the RIS controller 404 with the scheduling entity 401, 410 on Long-Term Evolution (LTE) frequency bands, Sub-6 GHz frequency bands, millimeter wave (mmW), and/or any given combination of those and/or other bands. It should be appreciated that the operating frequency ranges between the RIS controller 404 and the scheduling entity 401, 410 are not limited to the examples above. The operating frequency ranges may include any frequency band, any bandwidth part (BWP), any component carrier (CC), or combination thereof.

In addition, the RIS 402 may have its electro-mechanical capability to process certain frequency ranges to redirect a signal to a given direction. Before transmitting a signal to the RIS panel 402, a scheduling entity 401, 410 may have knowledge about the RIS frequency capability. Thus, the RIS controller 404 may transmit, to the scheduling entity 401, 410, a RIS frequency capability indication, which indicates communication support of the RIS 402 with a scheduling entity 401, 410 and a scheduled entity 408 on the one or more RIS operating frequency ranges. For example, the one or more RIS operating frequency ranges may include LTE frequency bands, Sub-6 GHz frequency bands, millimeter wave bands, and/or combination of those bands. The RIS operating frequency ranges may also include any frequency band, any bandwidth part (BWP), any component carrier (CC), or combination thereof. In other examples, the RIS 402 may also support inter-band carrier aggregation or intra-band carrier aggregation. The RIS frequency capability indication may be a separate and different message from the controller frequency capability indication. However, in some examples, the RIS controller 404 may transmit the RIS frequency capability indication with the controller frequency capability indication in the same message. The one or more RIS operating frequency ranges of the RIS 402 with a scheduling entity 401, 410 and a scheduled entity 408 may be the same as or different from (e.g., any suitable combination of) the one or more controller operating frequency ranges between the RIS controller 404 and the scheduling entity 401, 410.

In some examples, the RIS controller 404 may receive, from the scheduling entity 401, 410, RIS control information to control or configure the RIS 402 on the controller operating frequency ranges. The RIS control information may include one or more filtering parameters (e.g., one or more weights) corresponding to a set of the one or more RIS operating frequency ranges and/or corresponding to one or more RIS elements of the RIS panel 402. Based on the RIS control information, the RIS controller 404 may configure the RIS 402 to change or modify impinging signals on the RIS panel 402 to be redirected to given directions or scheduled entities 408. Thus, the RIS 402 may modify signals differently for each RIS operating band and/or each RIS element of the RIS.

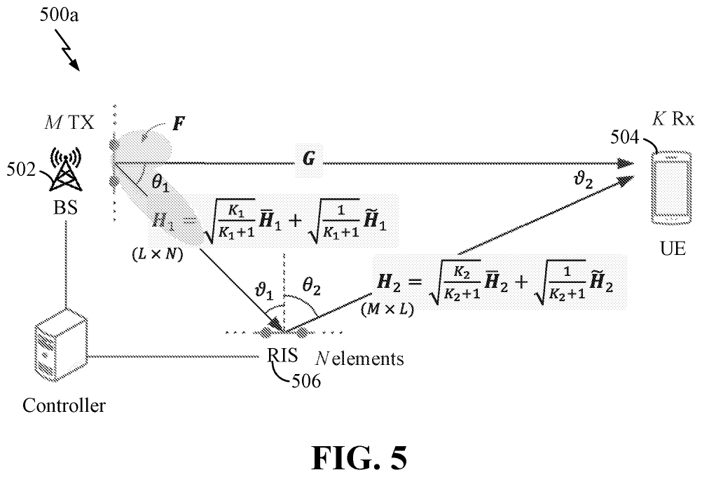

To facilitate operation of such a RIS and enable redirection of impinging signals as described above, the RIS may in some examples employ beamforming. As described above in relation to FIG. 3, beamforming may utilize precoding of communications via an array of RIS elements, with the precoding being based on a timely estimate of the communication medium or channel. FIG. 5 illustrates a channel estimation example between a scheduling entity 502 (e.g., base station) and a scheduled entity 504 (e.g., UE) through a RIS 506. The channel estimation or channel state information (CSI) between the scheduling entity 502 and the RIS 506 and between the RIS 506 and the scheduled entity 504, as described herein, might improve communication performance in terms of bit error rate and beamforming for impinging beams on the RIS to focus on the scheduled entity 504. The scheduling entity 402 may exploit channel properties to reduce overhead with higher estimating accuracy. In channel estimation of channels via the RIS, the signal overhead reduction may be possible through cascaded channel estimation. The scheduling entity 502 may sequentially estimate channel H₁ between the base station 502 and the RIS 506, and channel H₂ between the RIS 506 and the scheduled entity 504, in a cascaded manner. In cascaded channel estimation, the base station 502 may estimate channel H₁ and channel H₂ together. Channel H₁ may be expressed as

$${H}_{1} = \sqrt{\frac{{K}_{1}}{{K}_{1} + 1}} {\overline{H}}_{1} + \sqrt{\frac{1}{{K}_{1} + 1}} {\tilde{H}}_{1} .$$

Channel H₂ may be expressed as

$${H}_{2} = \sqrt{\frac{{K}_{2}}{{K}_{2} + 1}} {\overline{H}}_{2} + \sqrt{\frac{1}{{K}_{2} + 1}} {\tilde{H}}_{2} .$$

Here, K1 and K2 are the rician factors of the channel. H₁ and H₂ are LOS channels (also known as the rician component of the channel). A1 and A2 are the multipath components. In some examples, channel estimation for channel H₁ and channel H₂ may be separable with its scaling or quantity. Further, channel H₁ may be common to all scheduled entities 504. Thus, the overhead may be largely reduced by using such channel correlations among scheduled entities 504. Channel H₁ may be quasi-static in a case where there is no major mobility of the scheduling entity 502 and the RIS 506. Thus, the line-of-sight (LOS) between the base station 502 and the RIS 506 is a considering factor to deploy the RIS 506. Here, the optimal RIS codebook may be expressed as: Φ^{H}Φ=αI with a maximum value of α. The RIS codebook has orthogonal columns, and α is the norm of each column. Thus, minimum variance estimation is possible for a single scheduled entity 504.

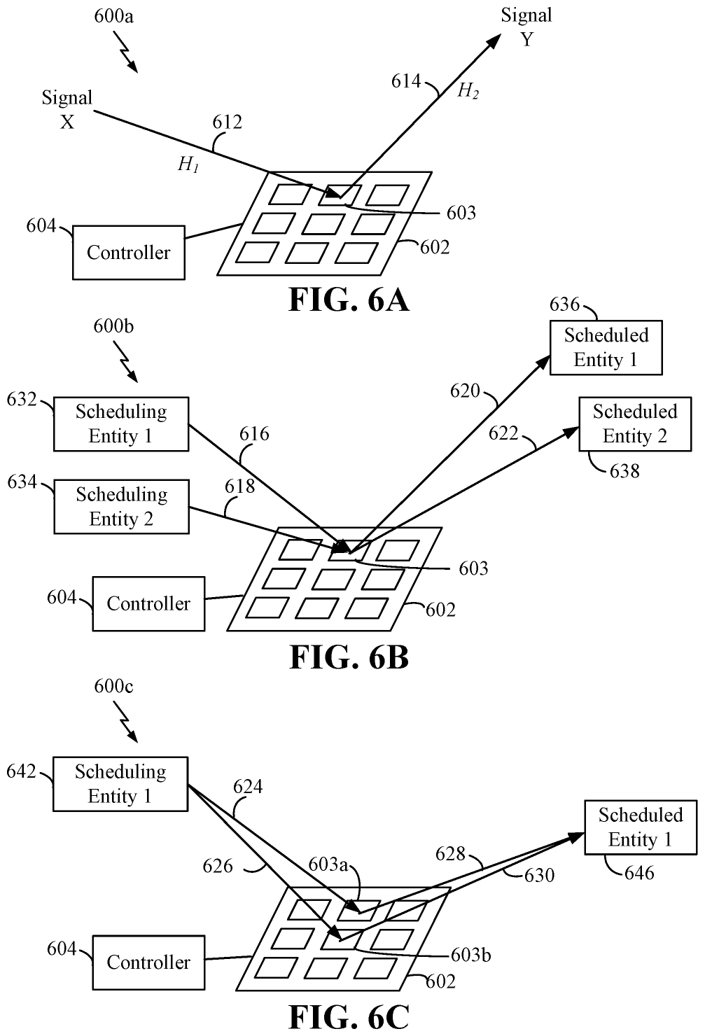

FIGS. 6A-6C are conceptual illustrations of examples of frequency and/or element dependent RIS communication according to some aspects of this disclosure. The RIS controller 604 may configure the RIS 602 based on one or more filtering parameters or weights received from a scheduling entity 632, 634, 642. The scheduling entity 632, 634, 642 may include a base station which communicates with the RIS controller 604 and/or a monitoring UE for sidelink communication through the RIS 602. However, the scheduling entity 632, 634, 642 may be any other suitable node to transmit and receive a signal to and from a scheduled entity. In some examples, software in the RIS controller 604 may adapt, configure, or reconfigure a frequency response of one or more RIS elements 603 of the RIS panel 602 based on the one or more filtering parameters from the scheduling entity. When a signal 612 is incident on the one or more of RIS elements 603 of the RIS panel 602, the configured one or more RIS elements 603 may change the phase, amplitude, frequency, and/or polarization of the impinging signal 612, and may redirect the incident signal 612 to a direction 614 (e.g., a direction predefined by the software). In some examples, to control a frequency response of the one or more RIS elements 603 of the RIS panel 602, the RIS controller 604 may control electronic devices including positive-intrinsic-negative (PIN) diodes, field-effect transistors (FETs), and/or micro-electromechanical system (MEMS) switches based on the received frequency response. However, it should be appreciated that the mechanism to control the properties of an impinging signal 612 on one or more RIS elements 603 of the RIS panel 602 is not limited to the listed examples. It could be any other suitable mechanism to control the properties of an incident signal 612 on the one or more RIS elements 603 to redirect the incident signal 612. For example, the RIS controller 604 may control the frequency response of the one or more RIS elements 503 by mechanically rotating the one or more RIS elements or controlling functional materials such as liquid crystal and/or graphene.

In some examples, the RIS controller 604 may configure the RIS 602 using at least in two different communication stages: 1) a communication initialization stage, and 2) a RIS communication stage. At the communication initialization stage before commencing communication of the RIS 602 with a scheduling entity 632, 634, 642 and a scheduled entity 636, 638, 646, the RIS controller 604 may receive one or more filtering parameters from the scheduling entity to configure one or more RIS elements 603 of the RIS panel 602. Thus, the configured RIS panel may adapt, configure, or modify the properties of the RIS, and thus, the reflecting direction of an incident signal 612. However, since the scheduling entity 632, 634, 642 or the RIS controller 604 may not know the scheduled entity 636, 638, 646 at the communication initialization stage, the RIS controller 604 may configure the RIS 602 to direct a future incident signal 612 to a certain direction 614 without knowing where the scheduled entity 636, 638, 646 is. In other examples, the RIS controller 604 may not receive one or more filtering parameters from the scheduling entity at the communication initialization stage. Then, the RIS 602 may exploit the generalized laws of reflection for broadcasting signals from the scheduling entity 632, 634, 642 for initial communication between the scheduling entity 632, 634, 642 and the scheduled entity 636, 638, 646. That is, the RIS 602 may redirect impinging signals based on the inherent phases or the inherent frequency response of the one or more RIS elements of the RIS panel 602.

At the RIS communication stage, the scheduling entity 632, 642 may estimate a communication channel between the scheduling entity 632, 642 and the scheduled entity 636, 646 through the RIS 602 in a cascaded way and may have knowledge about where the scheduled entity 636, 646 is. Based on the channel estimation, the scheduling entity 632, 642 may know a location of the scheduled entity 636, 646, the channel state information, and/or any other suitable information for the scheduling entity 632, 642 to control the RIS 602 to redirect a signal 616, 624 from the scheduling entity 632, 642, to the scheduled entity 636, 646. In some examples, if the scheduling entity 632, 642 is a monitoring UE for sidelink communication, the UE 632, 642 may transmit, to a base station, the channel estimation information between the UE 632, 642 and the RIS 602 and between the RIS 602 and the scheduled entity 636, 646. Based on the channel estimation, the base station may determine one or more filtering parameters to adapt, configure, or modify frequency responses of the RIS 602 to redirect a signal from the UE 632, 642 to the scheduled entity 636, 646. The base station, then, may transmit the one or more filtering parameters to the monitoring UE 632, 642. In other examples, the monitoring UE 632, 642 may determine the one or more filtering parameters and transmit the one or more filtering parameters to the scheduled entity 636, 646. The RIS controller 604 may receive the one or more filtering parameters from the scheduling entity 632, 642 and configure, based on the one or more filtering parameters, the RIS 602 for an incident signal 616, 624 from the scheduling entity 632, 642 to focus on the scheduled entity 636, 646. That is, the RIS controller 604 may modify one or more frequency responses of the RIS 602 based on the one or more filtering parameters for impinging signals 616, 624 to be redirected to the scheduled entity 636, 646. In some examples, the RIS controller 604 may control the RIS 602 to change a phase, amplitude, frequency, and/or polarization of the impinging signals 616, 624 and redirect the incident signal 616, 624 to the scheduled entity 636, 646.

FIG. 6A illustrates how the RIS 602 can modify an incident signal 612 on a RIS element 603 of the RIS panel 602 to be redirected to a given direction 614 according to some aspects of this disclosure. For example, each RIS element 603 of the RIS panel 602 may have its own default frequency response to shift a phase of the incident signal 612 to a certain direction. For example, when a scheduling entity transmits signal X on channel H₁ 612 to the RIS 602, the RIS element αe^{jφ} 603 of the RIS 602 receives H₁·signal X. The element of the RIS panel 602 may have the default or inherent frequency response, which may be expressed with the complex exponential e^{jφ} with a gain α of the element 603 of the RIS panel 602. The gain α of the element 603 of the RIS panel 602 may be any scalar (real) number. The gain α may be equal to or less than one (1) if the RIS is passive. However, in some examples, the gain α may be more than one (1). In addition, the RIS controller 604 may adapt, configure, reconfigure, or modify the frequency response αe^{jφ} with a filtering parameter (z). The filtering parameter (z) may be a complex or real number. Based on the configured phase of the RIS element 603 of the RIS panel 602, the RIS 602 may shift the phase of signal X and reradiate signal Y, which may correspond to a phase-shifted signal X, on channel H₂ 614 to a given direction. Then, the end-to-end channel may be expressed as: H₁·z·αe^{jφ}·H₂. Accordingly, signal Y may be expressed as: Signal Y=H₁·z·αe^{jφ}·H₂·signal X+noise. If N RIS elements 603 of the RIS panel 602 receive signal X via a plurality of beams corresponding N RIS elements and shift the phase of signal X, signal Y may be expressed as: Signal Y=Σₙ₌₁^{N}H₁ₙ·zₙ·αe^{jφ}^{ₙ}·H₂ₙ·signal X+noise.

The RIS controller 604 may adapt, configure, reconfigure, or modify the frequency response of the RIS panel, e.g., according to a filtering parameter received from a scheduling entity, to redirect the signal to a desired direction. Based on the filtering parameter for one or more RIS elements 603 of the RIS panel 602, the RIS controller 604 may configure or reconfigure a frequency response of a RIS element 603 of the RIS 602. Based on the formula above, the RIS controller 604 may configure one or more RIS elements 603 of the RIS panel 602 such that, e.g., an incident signal shifts its phase. Thus, constructive interference of the RIS elements' output signals are such that the incident signal is redirected to a given direction. The filtering parameter may be a real number to scale the amplitude of the redirected signal from the RIS panel 602 or a complex number to scale the amplitude of the redirected signal from the RIS panel 602 and/or shift the phase of the redirected signal. In addition, the filtering parameter might be a single number (real or complex) which may be applied across all the RIS elements. In some examples as shown in FIG. 6B, the filtering parameter might be a function of frequency, which may be applied across all the RIS elements, depending on the frequency. In other examples as shown in FIG. 6C, the filtering parameter might be a matrix having a number of elements or entries that is less than or equal to the number of RIS elements of the RIS panel 602.

FIG. 6B illustrates how the RIS 602 may support communication on one or more frequency ranges according to some aspects of this disclosure. If a RIS operating band is from f₁ to f₂, the RIS controller 604 may receive a filtering parameter, ϕ(f₁, f₂), which is a function of frequency. In some examples, the filtering parameter of ϕ(f₁, f₂) may be a scalar quantity or a real number. However, the filtering parameter is not limited to a scalar quantity. The filtering parameter may be a vector or a complex number. The filtering parameter of ϕ(f₁, f₂) may be used for configuring one or more RIS elements 603 of the RIS 602. The filtering parameter of ϕ(f₁, f₂) may modify the frequency response of the one or more RIS elements 603 of the RIS 602 to modify (e.g., redirect) an incident signal to a given direction. In some example, the RIS controller 604 may apply the filtering parameter of ϕ(f₁, f₂) to a part of RIS elements or the entire RIS elements 603 of the RIS 602.

For example, the RIS 602 may support frequency range 1 and frequency range 2. The RIS controller 604 may receive a filtering parameter, which is a function of frequency: filtering parameter 1 corresponding to frequency range 1 and filtering parameter 2 corresponding to frequency range 2. The RIS controller 604 may configure a first frequency response of the RIS 602 based on the filtering parameter 1 for frequency range 1 and a second frequency response of the RIS 602 based on filtering parameter 2 for frequency range 2. Thus, a first signal 616 on frequency range 1 from scheduling entity 1 (632) may be incident on a RIS element 603 of the RIS panel 602. The impinging first signal 616 may be redirected to scheduled entity 1 (636) based on the configured first frequency response of the RIS 602 in connection with filtering parameter 1. Similarly, a second signal 618 on frequency range 2 from scheduling entity 2 (634) may be incident on the same RIS element 603. The impinging second signal 618 may be redirected to scheduled entity 2 (636) based on the configured second frequency response of the RIS 602 in connection with filtering parameter 2. Accordingly, the RIS controller 604 may control one or more frequency responses of the RIS 602 for the one or more frequency ranges. Here, the one or more frequency ranges in connection with the one or more filtering parameters may be a part of or the same as the one or more RIS operating frequency ranges which the RIS may support in the RIS frequency capability indication.

FIG. 6C illustrates how the RIS controller 604 may control one or more RIS elements 603a, 603b of the RIS 602 according to some aspects of this disclosure. In some examples, the RIS 602 may include a plurality of RIS elements 603a, 603b. The RIS controller 604 may control one or more RIS elements of the plurality of RIS elements 603a, 603b. The RIS controller 604 may control any suitable set of one or more RIS elements 603 of the RIS 602. In some examples, the RIS controller 604 may receive a filtering parameter matrix corresponding to the one or more RIS elements of the plurality of RIS elements 603a, 603b. The RIS controller 604 may apply the filtering parameter matrix to one or more RIS elements of the plurality of RIS elements. The filtering parameter might be a matrix having equal to or less than the number of RIS elements of the RIS panel 602. For example, if the number of elements or entries in the filtering parameter matrix is the same as the number of RIS elements 603 in the RIS panel 602, each RIS element 603 of the RIS panel 602 may have its own filtering parameter for modifying the frequency response of the respective RIS element 603 of the RIS panel 602. If the number of entries in the filtering parameter matrix is less than the number of RIS elements 603 in the RIS panel 602, a group of RIS elements 603 of the RIS panel 602 may have its filtering parameter for modifying the frequency response of the respective group of RIS elements 603 of the RIS panel 602. In this case, the scheduling entity may notify to the RIS controller 604 about how to apply each filtering parameter to a respective group of RIS elements.

In some examples, the RIS may include a first set of RIS elements 603a and a second set of RIS elements 603b. The RIS controller 604 may receive two filtering parameters: filtering parameter 1 and filtering parameter 2. The RIS controller 604 may configure a first frequency response of the first set of RIS elements 603a based on filtering parameter 1 and configure a second frequency response of the second set of RIS elements 603b based on filtering parameter 2. Thus, a first signal 624 on a frequency range from a scheduling entity 1 (642) may be incident on the first set of RIS elements 603a. The impinging first signal 624 may be redirected to a scheduled entity 1 (646) based on the configured first frequency response of the RIS 602 in connection with filtering parameter 1. Similarly, a second signal 626 in the frequency range from the scheduling entity 1 (642) may be incident on the second set of RIS elements 603b. The impinging second signal 626 may be redirected to the same scheduled entity 1 (646) based on the configured second frequency response of the RIS 602. Accordingly, the RIS controller 604 may differently control one or more RIS elements 603a, 603b of the RIS 602.

In other examples, the RIS controller 604 may control one or more RIS elements of the plurality of RIS elements differently for each of the one or more frequency ranges. For example, the RIS panel 602 may support frequency range 1 and frequency range 2. The RIS controller 604 may receive four filtering parameters: filtering parameter 1, filtering parameter 2, filtering parameter 3, and filtering parameter 4. The RIS controller 604 may configure a first frequency response of the first set of RIS elements corresponding to frequency range 1 based on filtering parameter 1, a second frequency response of the first set of RIS elements corresponding to frequency range 2 based on filtering parameter 2, a third frequency response of the second set of RIS elements corresponding to frequency range 1 based on filtering parameter 3, and a fourth frequency response of the second set of RIS elements corresponding to frequency range 2 based on filtering parameter 4. Thus, a first impinging signal on frequency range 1 may be redirected based on the first frequency response of the first set of RIS elements 603a while a second impinging signal on frequency range 2 may be redirected based on the second frequency response of the first set of RIS elements 603a. In addition, a third impinging signal in frequency range 1 may be redirected based on the third frequency response of the first set of RIS elements 603a while a fourth impinging signal in frequency range 2 may be redirected based on the fourth frequency response of the second set of RIS elements 603b.

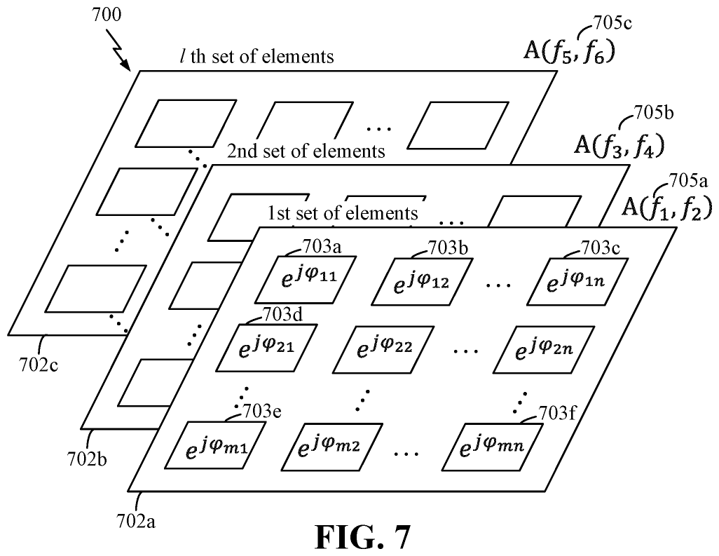

FIG. 7 is a conceptual illustration of some examples of a RIS panel that may be frequency and/or element dependent. For example, the RIS 702 may include/sets of RIS elements 702a, 702b, 702c. Each set of RIS elements may include m×n elements 703. The RIS 702 may support the/frequency ranges 705a, 705b, 705c. The first frequency range 705a is from frequency f₁ to frequency f₂, the second frequency range 705b is from frequency f₃ to frequency f₄, and the lth frequency range 705c is from frequency f₅ to frequency f₆. In some examples, the RIS controller may receive, from a scheduling entity, a filtering parameter for each frequency range 705a, 705b, 705c as explained above in connection with FIG. 6B. The RIS controller may apply a filtering parameter to the entire set of RIS elements of the RIS for each frequency range 705a, 705b, 705c. The filtering parameter for the frequency range 705a may the same as or different from the filtering parameter for other frequency ranges 705b, 705c. In other examples, the RIS controller may receive, from the scheduling entity, a filtering parameter for one or more RIS elements of the RIS panel 702a as explained above in connection with FIG. 6C. The RIS controller may configure each RIS element or each set of RIS elements 703 with its own frequency response e^{jφ}^{ₘₙ} along with the filtering parameter. For example, the RIS controller may receive a filtering parameter matrix

$$[ \begin{matrix}{w}_{11} & … & {w}_{1 n} \\ ⋮ & ⋱ & ⋮ \\ {w}_{m 1} & … & {w}_{mn}\end{matrix} ]$$

for RIS elements m×n of the RIS 702a, and the RIS panel may have a frequency response matrix

$$[ \begin{matrix}{e}^{j {φ}_{11}} & … & {e}^{j {φ}_{1 n}} \\ ⋮ & ⋱ & ⋮ \\ {e}^{j {φ}_{m 1}} & … & {e}^{j {φ}_{mn}}\end{matrix} ] .$$

In some examples, the frequency response matrix may also be expressed in the phase domain as

$$[ \begin{matrix}{φ}_{11} & … & {φ}_{1 n} \\ ⋮ & ⋱ & ⋮ \\ {φ}_{m 1} & … & {φ}_{mn}\end{matrix} ] ,$$

which may be the same as

$$[ \begin{matrix}{e}^{j {φ}_{11}} & … & {e}^{j {φ}_{1 n}} \\ ⋮ & ⋱ & ⋮ \\ {e}^{j {φ}_{m 1}} & … & {e}^{j {φ}_{mn}}\end{matrix} ]$$

as expressed on exponential domain. The RIS controller 702 may modify the frequency response of the RIS panel 704 on phase domain by applying the filtering parameter to the frequency response matrix on the phase domain. In some examples, if the filtering parameter is a matrix

$$[ \begin{matrix}{w}_{11} & … & {w}_{1 n} \\ ⋮ & ⋱ & ⋮ \\ {w}_{m 1} & … & {w}_{mn}\end{matrix} ]$$

for RIS elements m×n of the RIS 702a, the application of the filtering parameter matrix to the frequency response matrix of the RIS panel

$$[ \begin{matrix}{e}^{j {φ}_{11}} & … & {e}^{j {φ}_{1 n}} \\ ⋮ & ⋱ & ⋮ \\ {e}^{j {φ}_{m 1}} & … & {e}^{j {φ}_{mn}}\end{matrix} ]$$

may use the Hadamard product, which is element-by-element multiplication. For example, the Hadamard product of the filtering parameter matrix

$$[ \begin{matrix}{w}_{11} & … & {w}_{1 n} \\ ⋮ & ⋱ & ⋮ \\ {w}_{m 1} & … & {w}_{mn}\end{matrix} ]$$

and the frequency response matrix of the RIS panel

$$[ \begin{matrix}{e}^{j {φ}_{11}} & … & {e}^{j {φ}_{1 n}} \\ ⋮ & ⋱ & ⋮ \\ {e}^{j {φ}_{m 1}} & … & {e}^{j {φ}_{mn}}\end{matrix} ]$$

may be expressed as:

$$[ \begin{matrix}{w}_{11} & … & {w}_{1 n} \\ ⋮ & ⋱ & ⋮ \\ {w}_{m 1} & … & {w}_{mn}\end{matrix} ] ∘ [ \begin{matrix}{e}^{j {φ}_{11}} & … & {e}^{j {φ}_{1 n}} \\ ⋮ & ⋱ & ⋮ \\ {e}^{j {φ}_{m 1}} & … & {e}^{j {φ}_{mn}}\end{matrix} ] = [ \begin{matrix}{w}_{11} {e}^{j {φ}_{11}} & … & {w}_{1 n} {e}^{j {φ}_{1 n}} \\ ⋮ & ⋱ & ⋮ \\ {w}_{m 1} {e}^{j {φ}_{m 1}} & … & {w}_{mn} {e}^{j {φ}_{mn}}\end{matrix} ] .$$

In other examples, if the filtering parameter is a single weight, the weight may be applied to each element of the RIS panel. Thus, the RIS panel 704 may change the phase of an impinging signal on the RIS panel and redirect the signal to a given direction. In other examples, the RIS controller 702 may modify the frequency response of the RIS panel 704 on the exponential domain by applying the filtering parameter to the frequency response matrix on the exponential domain. Thus, the RIS panel 704 may change the phase and/or amplitude of an impinging signal on the RIS panel 704 and redirect the signal to a given direction. The frequency response matrix may be time-invariant and be determined by physical characteristics of the RIS elements of the RIS 702. In addition, the frequency response matrix may be a function of frequency. Thus, the frequency matrix may have different indices 702a, 702b, 702c depending on frequencies 705a, 705b, 705c. The RIS controller may modify frequency responses of the RIS elements of the RIS based on the filtering parameter matrix. Based on the configured RIS 702, an impinging signal on one or more RIS elements of the RIS may shift the phase and/or scale the amplitude of the signal and travel to a given direction. In other examples, the RIS controller 702 may receive one or more frequency responses for one or more RIS elements of the RIS to be frequency dependent and at the same time element dependent.

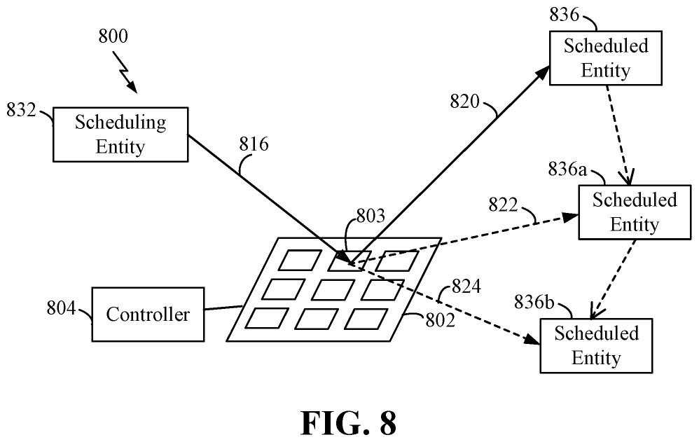

FIG. 8 illustrates the RIS panel 802 for adapting to time-varying channel characteristics according to some aspects of this disclosure. In some examples, a scheduled entity 836 (e.g., a UE) may swiftly change the position such that the scheduled entity 836 may be moving from a place 836 to another place 836a and 836b. In some examples, the RIS controller 804 may keep reconfiguring the RIS to redirect the signal 816 from the scheduling entity 832 for following the mobility of the scheduled entity 836. Thus, the RIS 802 may keep shifting the phase of the signal 816 and retransmit the shifted signal 822, 824 to the moving scheduled entity 836a, 836b. In other examples, the RIS controller 804 may filter or refine frequency responses of the RIS to adapt to any time-varying channel characteristics. In some examples, the filtering of the frequency responses of the RIS 802 over time may capture the mobility of the scheduled entity 836 and reduce Doppler-induced distortions in estimated signals 822, 824.

In some examples, for the filtering, the RIS controller 804 may transmit a filtering capability indication for indicating filtering support of the RIS panel 802. The RIS controller 804 may inform, to the scheduling entity 832, the capability of the RIS 802 to adapt to any time varying channel characteristics. The transmission from the RIS controller 804 to the scheduling entity 832 may be via a radio resource control (RRC) message, or any other suitable message. The scheduling entity 836 may transmit a filtering enabling indication for enabling the filtering of the RIS panel 802. In some examples, the scheduling entity 832 may enable the filtering for a predetermined time. The transmission from the scheduling entity 832 to the RIS controller 804 may be via a radio resource control (RRC) message, a downlink control information (DCI) message, or any other suitable message.

The scheduling entity 832 may estimate a communication channel between the scheduling entity 832 and the scheduled entity via the RIS panel 802 in a cascaded way. In some examples, the scheduling entity 832 may determine the filtering parameter for filtering coefficients based on the channel estimation. In particular, the scheduling entity 832 may help characterize a filter or obtain an impulse response per phase, amplitude, or complex coefficient of one or more RIS elements 803 of the RIS 802. The filtering may help in temporal optimization of the RIS elements 803 of the RIS 802 to achieve optimal performance for the scheduling entity 832 and the scheduled entity 836 utilizing the RIS 802. The impulse response may include infinite impulse response (IIR), finite impulse response (FIR), or any other suitable impulse response. In other examples, the scheduling entity 832 (e.g., a monitoring UE for sidelink communication) may transmit the channel estimation information to a base station to determine a filtering parameter for the filtering of the RIS. After determining the filtering parameter, the scheduling entity 832 may transmit the filtering parameter to the RIS controller 804. The RIS controller 804, then, may receive the filtering parameter and determine filtering coefficients based on the filtering parameter. The RIS controller 804, then, may configure the frequency responses of the RIS panel 802 by applying a first filtering coefficient to a default frequency responses of the RIS panel 802 and applying a second filtering coefficient to a previous configured frequency responses of the RIS panel 802.

In some examples, matrix A may indicate default frequency responses or phases with or without amplitudes of corresponding RIS elements 803 of the RIS panel 802. If there are m×n RIS elements 803 in the RIS 802, matrix A may be expressed as

$$[ \begin{matrix}{e}^{j {φ}_{11}} & … & {e}^{j {φ}_{1 n}} \\ ⋮ & ⋱ & ⋮ \\ {e}^{j {φ}_{m 1}} & … & {e}^{j {φ}_{mn}}\end{matrix} ]$$

in the exponential domain. In some examples, the matrix A may also be expressed as

$$[ \begin{matrix}{φ}_{11} & … & {φ}_{1 n} \\ ⋮ & ⋱ & ⋮ \\ {φ}_{m 1} & … & {φ}_{mn}\end{matrix} ]$$

in the phase domain for the RIS panel 802 to change the phase of an impinging signal. Thus, the RIS controller 804 may use filtering parameters modify phase responses of RIS elements 803 of the RIS panel 802 the phase domain and/or exponential domain. For an adaptive filtering function, the scheduling entity 832 may determine and transmit RIS control information to the RIS controller 804. The RIS controller 804 may include one or more filtering parameters. The RIS controller 804 may determine one or more filtering coefficients based on the one or more filtering parameters. The RIS controller 804 may refine or filter the frequency responses of the RIS using the one or more filtering coefficients.

In some examples, the modified frequency response may be expressed as: ϕ^{t}=f^{t-1} ϕ^{t-1}+f^{t-2}ϕ^{t-2}+ . . . +f^{t-n}ϕ^{t-n}+f⁰ϕ⁰ as a linear function, where ϕ may be the modified frequency response of the RIS panel 802, each f^{c} may be a filtering coefficient, and ϕ⁰ may be the default frequency response of the RIS panel 802 (e.g., ϕ⁰=A). The RIS controller 804 may receive one or more filtering parameters α. Based on the one or more filtering parameters a, the RIS controller 804 may determine one or more filtering coefficients (f^{c}) which may be a time invariant function of the received filtering parameter(s) a. The RIS controller 804 may determine the filtered frequency responses of the RIS panel 802 at time 1, ϕ¹=f₀ϕ⁰, since ϕ⁰ is default frequency responses of the RIS panel 802. The RIS controller may store the filtered frequency responses of the RIS panel 802. By calculating and storing the history of the filtered frequency responses, The RIS controller 804 may determine the filtered frequency responses of the RIS panel 802 at time t, ϕ^{t}=f^{t-1} ϕ^{t-1}+f^{t-2}ϕ^{t-2}+ . . . +f^{t-n}ϕ^{t-n}+f⁰ϕ⁰. Here, each value of f may be a filtering coefficient and can potentially be any function of the received parameter, frequency, and/or element of the RIS panel 802. Thus, the filtering may be a function of time (t), filtering parameter (α), and the default frequency response of the RIS panel 802 (A), ¢(t, α, A). The filtering parameter a can be a complex number, which could potentially affect the amplitude and phase of the output signal. The default matrix A may already be a complex number, representing the frequency response of the RIS panel 802 or RIS elements 803 of the RIS panel 802. ϕ, α, and A can all potentially be matrices.

In some examples, f⁰ may be a filtering parameter, a, f^{t-1} may be (1−α), and f^{t-2} through f^{t-n} may be 0. The filtering, then, may be expressed as: ϕ^{t}=αA+(1−α)ϕ^{t-1}, where a is a filtering parameter received from the scheduling entity 832, a and (1−α) are filtering coefficients, and ϕ^{t} is a refined or filtered frequency response matrix of the RIS at time t. The filtering coefficient may be a constant value or a function of time. In some examples, if the filtering parameter α is an m×n matrix and the default frequency response A is also an m×n matrix, αA may use the Hadamard product of the filtering parameter matrix α and the default frequency response A. Thus, the RIS controller 804 may configure the RIS panel 802 or filter frequency responses of the RIS panel 802 based on the filtering parameter a, a previous filtered configuration of the RIS panel 802 ϕ^{t-1}, and the default frequency responses of the RIS panel 802 A. Since the filtered matrix ϕ^{t} may consider the previous filtered configuration of the RIS panel 802 ϕ^{t-1}, the RIS controller 804 may perform the filtering for a predetermined period of time to reflect previous filtered matrices in the filtering. The initial filtered matrix, ϕ⁰, may be the same as the default frequency response matrix A. This may be expressed as ϕ⁰=A.

In some examples, the filtering parameter α may be a real number to scale the frequency responses of the RIS elements 803 of the RIS panel 802 or a complex number to scale the amplitude of the redirected signal from the RIS panel 802 and shift the phase of the redirected signal. In some examples, the filtering parameter may be a function of frequency. The filtering parameter, the result of the function of frequency, may be a real or complex number which may vary per frequency. In other examples, the filtering parameter may be a matrix having equal to or less than the number of RIS elements 803 of the RIS panel 802. For example, if the number of entries in the filtering parameter matrix is the same as the number of RIS elements 803 in the RIS panel 802, each RIS element 803 of the RIS panel 802 may have its own filtering parameter α for applying a filtering coefficient (α) to frequency responses of the RIS (e.g., matrix A) and for applying another filtering coefficient (1−α) to the previous filtered frequency responses of the RIS (e.g., matrix ϕ^{t-1}). If the number of entries in the filtering coefficient matrix is less than the number of RIS elements 803 in the RIS panel 802, a group of RIS elements 803 of the RIS panel 802 may have its filtering parameter for modifying the frequency response of the respective group of RIS elements 803 of the RIS panel 802. In this case, the scheduling entity may notify to the RIS controller 804 about how to apply each filtering coefficient to a respective group of RIS elements.

In some example, a default or inherent RIS filter matrix A may be expressed in the exponential domain as

$$[ \begin{matrix}{e}^{j {φ}_{11}} & … & {e}^{j {φ}_{1 n}} \\ ⋮ & ⋱ & ⋮ \\ {e}^{j {φ}_{m 1}} & … & {e}^{j {φ}_{mn}}\end{matrix} ] .$$

This characterizes an array of m×n RIS elements 803. For example, e^{jφ}^{₁₁} may represent the inherent frequency response of the RIS element 11. A filtering parameter a, which is the parameter that the base station sends to the RIS controller 804, may be expressed as

$$[ \begin{matrix}{w}_{11} & … & {w}_{1 n} \\ ⋮ & ⋱ & ⋮ \\ {w}_{m 1} & … & {w}_{mn}\end{matrix} ] ,$$

where each w can be a complex number. The resulting generalized frequency response at time (t) as ϕ^{t}=f^{t-1} ϕ^{t-1}+f^{t-2}ϕ^{t-2}+ . . . +f^{t-n}ϕ^{t-n}+f⁰ϕ⁰. Here, the value ϕ⁰ is the RIS frequency response at time zero, which is equivalent to the default RIS filter matrix A. Each of the variables (ϕ, f) in this equation is also an m×n matrix corresponding to the m×n RIS elements 803. The RIS controller 804 may apply the received filtering parameter α to calculate each of the filtering coefficient(s) f^{c} according to its particular configuration: i.e., the RIS controller 804 may have a known equation and apply to a to generate each filtering coefficient f^{c}. For example, the RIS controller 804 may calculate the filtering coefficient as: f⁰=α, f^{t-1}=(1−α), and all other f may be set to 0. Here, αϕ⁰ and (1−α)ϕ^{t-1} may use the Hadamard product. The RIS controller 804 may then apply the resulting value of ϕ^{t}, which represents each RIS element being filtered by the parameter of the corresponding index within ϕ^{t}.

### Scheduling Entity

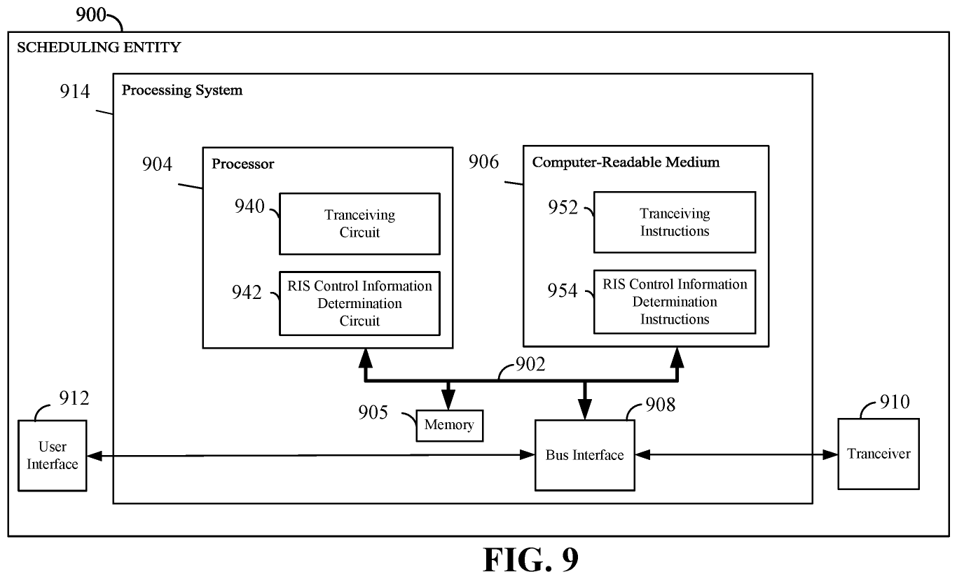

FIG. 9 is a block diagram illustrating an example of a hardware implementation for a scheduling entity 900 employing a processing system 914. For example, the scheduling entity 900 may include a base station, a user equipment (UE), or any other suitable node as illustrated in any one or more of FIGS. 1 and/or 2.

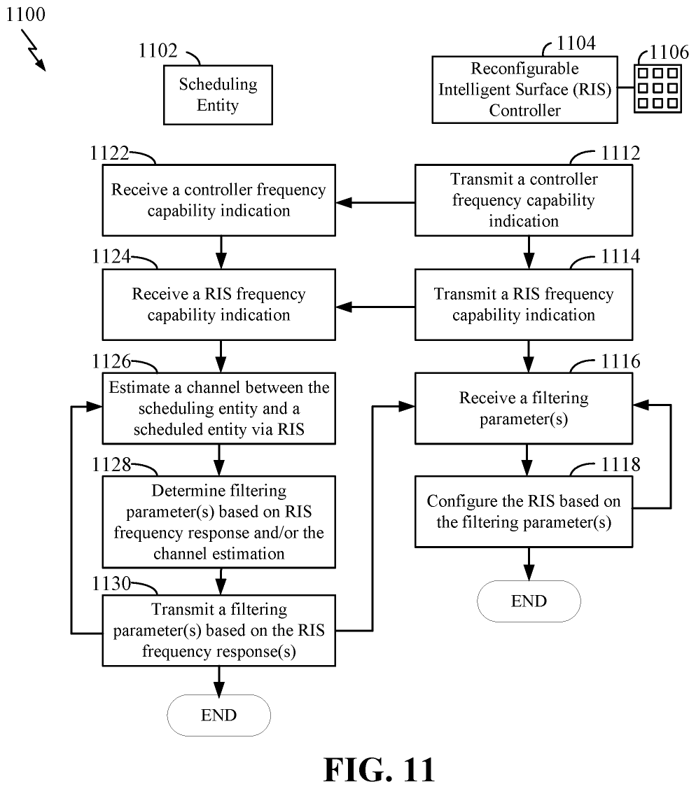

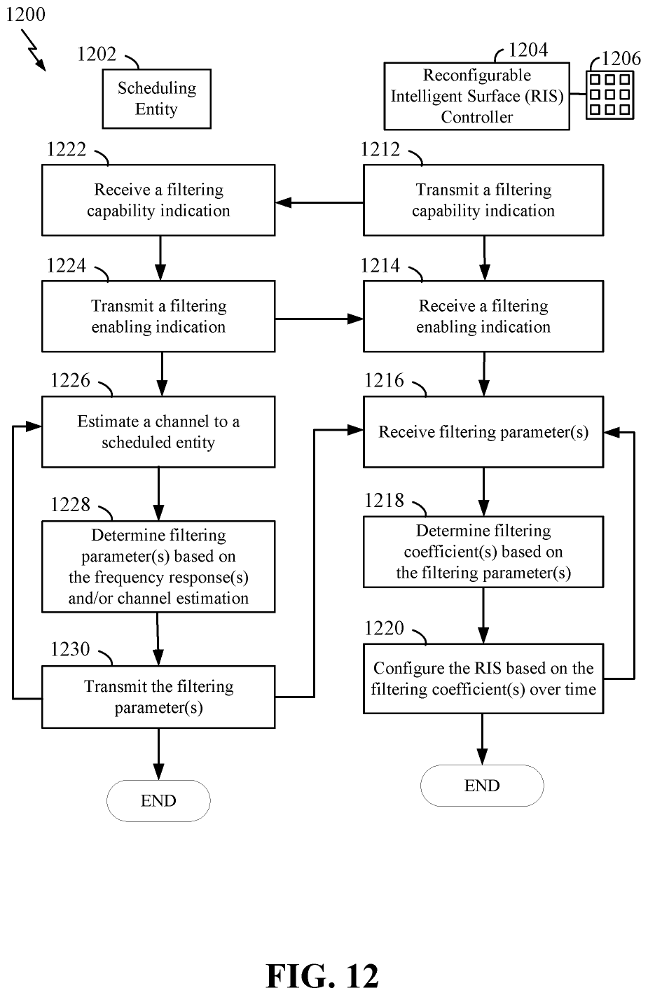

The scheduling entity 900 may include a processing system 914 having one or more processors 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 900 may be configured to perform any one or more of the functions described herein. That is, the processor 904, as utilized in a scheduling entity 900, may be configured (e.g., in coordination with the memory 905) to implement any one or more of the processes and procedures described below and illustrated in FIGS. 11-12.

The processing system 914 may be implemented with a bus architecture, represented generally by the bus 902. The bus 902 may include any number of interconnecting buses and bridges depending on the specific application of the processing system 914 and the overall design constraints. The bus 902 communicatively couples together various circuits including one or more processors (represented generally by the processor 904), a memory 905, and computer-readable media (represented generally by the computer-readable medium 906). The bus 902 may also link various other circuits such as timing sources, peripherals, voltage regulators, and power management circuits, which are well known in the art, and therefore, will not be described any further. A bus interface 908 provides an interface between the bus 902 and a transceiver 910. The transceiver 910 provides a communication interface or means for communicating with various other apparatus over a transmission medium. Depending upon the nature of the apparatus, a user interface 912 (e.g., keypad, display, speaker, microphone, joystick) may also be provided. Of course, such a user interface 912 is optional, and some examples, such as a base station or a RIS, may omit it.

In some aspects of the disclosure, the processor 904 may include transceiving circuitry 940 configured (e.g., in coordination with the memory 905) for various functions, including, e.g., receiving a controller frequency capability indication, receiving a RIS frequency capability indication, transmitting one or more filtering parameters, transmitting a filtering enabling indication, and/or transmitting one or more filtering parameters. For example, the transceiving circuitry 940 may be configured to implement one or more of the functions described below in relation to FIGS. 11-12, including, e.g., blocks 1122, 1124, 1130, 1222, 1224, and/or 1230.

In some aspect of the disclosure, the processor 904 may also include RIS control information determination circuitry 942 configured (e.g., in coordination with the memory 905) for various functions, including, e.g., estimating a channel between the scheduling entity and the scheduled entity via the RIS panel, determining filtering coefficients, and/or determining one or more filtering parameters. For example, the RIS control information determination circuitry 940 may be configured to implement one or more of the functions described below in relation to FIGS. 11-12, including, e.g., blocks 1126, 1128, 1218, 1228, and/or 1230.

The processor 904 is responsible for managing the bus 902 and general processing, including the execution of software stored on the computer-readable medium 906. The software, when executed by the processor 904, causes the processing system 914 to perform the various functions described below for any particular apparatus. The processor 904 may also use the computer-readable medium 906 and the memory 905 for storing data that the processor 904 manipulates when executing software.

One or more processors 904 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 906. The computer-readable medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 906 may reside in the processing system 914, external to the processing system 914, or distributed across multiple entities including the processing system 914. The computer-readable medium 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 906 may store computer-executable code that includes transceiving instructions 952 that configure a scheduling entity 900 for various functions, including, e.g., receiving a controller frequency capability indication, receiving a RIS frequency capability indication, transmitting one or more filtering parameters, transmitting a filtering enabling indication, and/or transmitting one or more filtering parameters. For example, the transceiving instructions 952 may be configured to cause a scheduling entity 900 to implement one or more of the functions described below in relation to FIGS. 11-12, including, e.g., blocks 1122, 1124, 1130, 1222, 1224, and/or 1230. The computer-readable storage medium 906 may further store computer-executable code that includes RIS control information determination instructions 954 that configure a scheduling entity 900 for various functions, including, e.g., estimating a channel between the scheduling entity and the scheduled entity via the RIS panel, determining filtering coefficients, and/or determining one or more filtering parameters. The RIS control information determination instructions 954 may be configured to cause a scheduling entity 900 to implement one or more of the functions described below in relation to FIGS. 11-12, including, e.g., blocks 1126, 1128, 1218, 1228, and/or 1230.

In one configuration, the apparatus 900 for wireless communication includes means for receiving a controller frequency capability indication, receiving a RIS frequency capability indication, transmitting one or more filtering parameters, transmitting a filtering enabling indication, transmitting one or more filtering parameters, estimating a channel between the scheduling entity and the scheduled entity via the RIS panel, determining filtering coefficients, and/or determining one or more filtering parameters. In one aspect, the aforementioned means may be the processor(s) 904 shown in FIG. 9 configured to perform the functions recited by the aforementioned means. In another aspect, the aforementioned means may be a circuit or any apparatus configured to perform the functions recited by the aforementioned means.

Of course, in the above examples, the circuitry included in the processor 904 is merely provided as an example, and other means for carrying out the described functions may be included within various aspects of the present disclosure, including but not limited to the instructions stored in the computer-readable storage medium 906, or any other suitable apparatus or means described in any one of the FIGS. 1 and/or 2, and utilizing, for example, the processes and/or algorithms described herein in relation to FIGS. 11 and/or 12.

### Ris Controller

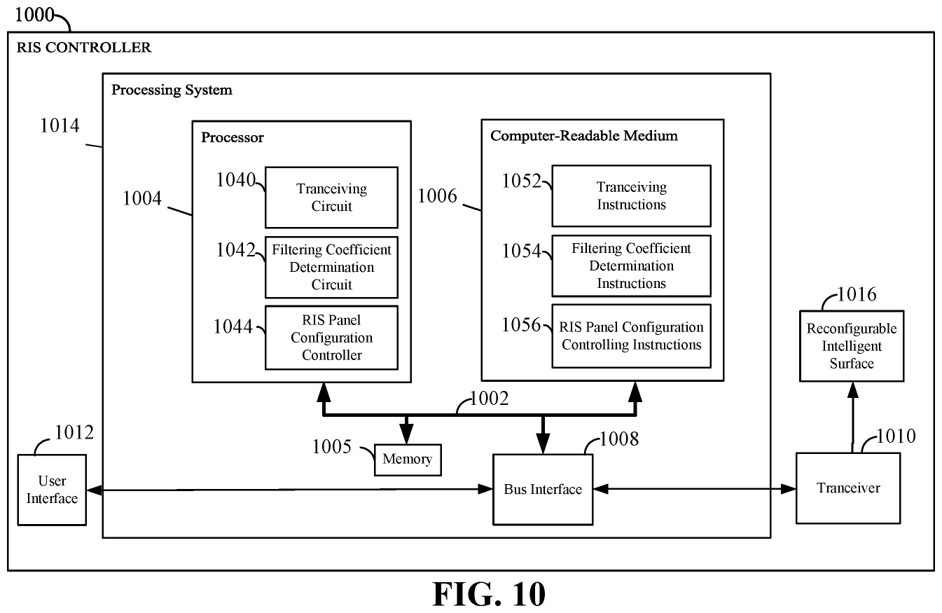

FIG. 10 is a conceptual diagram illustrating an example of a hardware implementation for an exemplary RIS controller 1000 employing a processing system 1014. In accordance with various aspects of the disclosure, a processing system 1014 may include a RIS element, or any portion of a RIS element, or any combination of RIS elements having one or more processors 1004. For example, the RIS controller 1000 may be any suitable device to transmit and receive a signal, and control a RIS as illustrated in any one or more of FIGS. 1 and/or 2.

The processing system 1014 may be substantially the same as the processing system 914 illustrated in FIG. 9, including a bus interface 1008, a bus 1002, memory 1005, a processor 1004, and a computer-readable medium 1006. In some examples, the RIS controller 1000 may optionally include a user interface 1012. And in further examples, the RIS controller 1000 may include a transceiver 1010, e.g., substantially similar to those described above in FIG. 9. In some examples, the RIS controller 1000 may include a RIS panel 1016, which may be substantially similar to the RIS panel 402 described above in connection with FIG. 4. In other examples, the RIS panel 1016 may be a separate entity to be controlled by the RIS controller 1000. The processor 1004, as utilized in a RIS controller 1000, may be configured (e.g., in coordination with the memory 1005) to implement any one or more of the processes described below and illustrated in FIGS. 11-12.

In some aspects of the disclosure, the processor 1004 may include transceiving circuitry 1040 configured (e.g., in coordination with the memory 1005) for various functions, including, for example, transmitting a controller frequency capability indication, transmitting a RIS frequency capability indication, receiving one or more filtering parameters, transmitting a filtering capability indication, receiving a filtering enabling indication, and/or receiving one or more filtering parameters. For example, the transceiving circuitry 1040 may be configured to implement one or more of the functions described below in relation to FIGS. 11-12, including, e.g., blocks 1112, 1114, 1116, 1212, 1214, and/or 1216.

In some aspects of the disclosure, the processor 1004 may further include filtering coefficient determination circuit 1042 configured (e.g., in coordination with the memory 1005) for various functions, including, for example, determining one or more filtering coefficients. For example, the filtering coefficient determination circuit 1042 may be configured to implement one or more of the functions described below in relation to FIG. 12, including, e.g., block 1218.

In some aspects of the disclosure, the processor 1004 may further include a RIS panel configuration controller 1044 configured (e.g., in coordination with the memory 1005) for various functions, including, for example, configuring the RIS panel, configuring one or more filtering characteristics, applying one or more filtering coefficients to one or more filtering characteristics of the RIS panel, and/or applying one or more filtering coefficients to a recursive function. For example, the RIS panel configuration 1044 may be configured to implement one or more of the functions described below in relation to FIGS. 11-12, including, e.g., blocks 1118 and/or 1220.

And further, the computer-readable storage medium 1006 may store computer-executable code that includes transceiving instructions 1052 that configure a scheduled entity 1000 for various functions, including, e.g., transmitting a controller frequency capability indication, transmitting a RIS frequency capability indication, receiving one or more filtering parameters, transmitting a filtering capability indication, receiving a filtering enabling indication, and/or receiving one or more filtering parameters. For example, the transceiving instructions 1052 may be configured to cause a scheduled entity 1000 to implement one or more of the functions described below in relation to FIGS. 11-12, including, e.g., blocks 1112, 1114, 1116, 1212, 1214, and/or 1216.

The computer-readable storage medium 1006 may also store computer-executable code that includes filtering coefficient determination instructions 1054 that configure a scheduled entity 1000 for various functions, including, e.g., determining one or more filtering coefficients. For example, the filtering coefficient determination instructions 1054 may be configured to cause a scheduled entity 1000 to implement one or more of the functions described below in relation to FIG. 12, including, e.g., block 1218.

The computer-readable storage medium 1006 may also store computer-executable code that includes RIS panel configuration instructions 1056 that configure a scheduled entity 1000 for various functions, including, e.g., configuring the RIS panel, configuring one or more filtering characteristics, applying one or more filtering coefficients to one or more filtering characteristics of the RIS panel, and/or applying one or more filtering coefficients to a recursive function. For example, the RIS panel configuration 1056 may be configured to cause a scheduled entity 1000 to implement one or more of the functions described below in relation to FIGS. 11-12, including, e.g., blocks 1118 and/or 1220.

In one configuration, the apparatus 1000 for wireless communication includes means for transmitting a controller frequency capability indication, transmitting a RIS frequency capability indication, receiving one or more filtering parameters, transmitting a filtering capability indication, receiving a filtering enabling indication, receiving one or more filtering parameters, determining one or more filtering coefficients, configuring the RIS panel, configuring one or more filtering characteristics, applying one or more filtering coefficients to one or more filtering characteristics of the RIS panel, and/or applying one or more filtering coefficients to a recursive function. In one aspect, the aforementioned means may be the processor(s) 1004 shown in FIG. 10 configured to perform the functions recited by the aforementioned means. In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable storage medium 1006, or any other suitable apparatus or means described in any one of the FIGS. 1 and/or 2, and utilizing, for example, the processes and/or algorithms described herein in relation to FIGS. 11 and/or 12.

FIG. 11 is a flow chart illustrating an exemplary process 1100 for RIS communication for one or more RIS frequency ranges in accordance with some aspects of the present disclosure. As described below, a particular implementation may omit some or all illustrated features, and may not require some illustrated features to implement all embodiments. For example, a scheduling entity 900 illustrated in FIG. 9 may include a base station, a monitoring UE for sidelink communication, or any other suitable node to carry out the process 1100. In some examples, any suitable apparatus or means for carrying out the functions or algorithm described below may carry out the process 1100.

At blocks 1112 and 1122, the RIS controller 1104 and the scheduling entity 1102 may perform an initial handshake procedure to be connected each other. In the initial handshake procedure, the RIS controller 1104 may implicitly transmit a controller frequency capability indication for indicating communication support on one or more controller operating bands. In some examples, the RIS controller 1104 may explicitly transmit the controller frequency capability indication to the scheduling entity 1102 in a separate message. The transmission of the controller frequency capability indication may be via an RRC message or any other suitable message.

At blocks 1114 and 1124, the RIS controller 1104 may transmit, and the scheduling entity 1102 may receive, a RIS frequency capability indication for indicating communication support on one or more RIS operating frequency ranges. A RIS 1106 may have a given (e.g., limited) capability to operate over certain frequency ranges. Before transmitting a signal to the scheduled entity through the RIS 1106, the scheduling entity 1102 may have knowledge about this RIS capability. The RIS operating frequency ranges may include any frequency band, any bandwidth part (BWP), any component carrier (CC), or combination thereof. The RIS 1106 may inform the capability to the RIS controller 1104, or the RIS controller 1104 may determine the RIS' capability by accessing the RIS 1106 or exploiting any other suitable means. The RIS controller 1104, then, may transmit the RIS frequency capability indication, which may include the RIS' capability to support communication of the RIS 1106 on one or more RIS operating frequency ranges, to the scheduling entity 1102.

At block 1126, the scheduling entity 1102 may estimate a channel to the scheduled entity via the RIS panel in a cascaded way. Based on the channel estimation, the scheduling entity 1102 may know a location of the scheduled entity and/or the channel state information. In addition, the scheduling entity 1102 may receive, from the RIS controller 1104, information about the default frequency response of the RIS panel 1106. The default frequency response may be determined by the inherent characteristics of the RIS panel 1106 for an impinging signal on the RIS panel 1106 to be redirected in a natural way. In some examples, the default frequency response of the RIS panel 1106 may be expressed as a matrix. Each index in the matrix may correspond to a respective RIS element in the RIS panel 1106. Since the default frequency response of the RIS panel 1106 is determined by the inherent features of the RIS panel 1106, the scheduling entity 1102 may not determine the default frequency response of the RIS panel 1106.

At block 1128, the scheduling entity 1102 may determine one or more filtering parameters based on the default RIS frequency response and/or the channel estimation to modify the frequency response of the RIS panel 1106 by applying the one or more filtering parameters to the default RIS frequency response. Thus, an incident signal on the RIS panel 1106 may be directed to the scheduled entity in beamforming based on the modified frequency response of the RIS panel. Based on the default frequency response of the RIS panel 1106, the scheduling entity may determine certain RIS control information, which may include one or more filtering parameters. In some examples, the scheduling entity 1102 may configure the filtering parameters to be a function of frequency, e.g., to vary per frequency. The frequency ranges in connection with the one or more filtering parameters might be the same as or a part of the one or more RIS operating frequency ranges. In addition, the one or more filtering parameters may correspond to one or more RIS elements of a plurality of RIS elements of the RIS 1106.

At block 1130, the scheduling entity 1102 may transmit the RIS control information to the RIS controller 1104. The RIS control information may be further based on the controller frequency capability indication. Blocks 1132, 1134, 1136 may be repeated when the estimated channel changes. However, blocks 1132, 1134, and 1136 may be repeated for any other suitable reason.

At block 1116, the RIS controller 1104 may receive (e.g., via the transceiver 1010) the RIS control information.

At block 1118, the RIS controller 1104 may configure the RIS panel 1106 based on the RIS control information. In particular, the RIS controller 1104 may apply the one or more filtering parameters in the RIS control information to corresponding one or more frequency responses of one or more RIS elements in the RIS panel 1106. The application may include, e.g., multiplying the one or more filtering parameters with the default frequency responses of the RIS panel 1106. The one or more filtering parameters may be a complex number to shift the phase (e.g., the angle of the complex number in the complex plane) and/or scale the amplitude (e.g., the magnitude of the complex number) of the frequency responses of the RIS panel 1106. In other examples, application of filtering parameters may include calculating one or more filter coefficients utilizing any suitable function, and applying the filtering coefficients to the frequency response of the RIS panel 1106 utilizing any suitable equation, including but not limited to a linear difference equation. Thus, the application may modify frequency responses corresponding to one or more RIS elements of the RIS panel 1106 for an impinging signal on the RIS panel 1106 from the scheduling entity 1102 to shift its phase of the signal. The scaled and/or phase-shifted signal may change its direction to be retransmitted and/or focused towards the scheduled entity. Blocks 1116 and 1118 may be repeated when the RIS controller 1104 receives updated RIS control information from the scheduling entity 1102. However, blocks 1116, 1118 may be repeated any other suitable reason.

FIG. 12 is a flow chart illustrating an exemplary process 1210 for RIS communication for adapting to time varying channel characteristics in accordance with some aspects of the present disclosure. In some examples, when the scheduled entity and/or the scheduling entity 1202 moves, the RIS controller 1204 may configure the RIS panel 1206 to capture the mobility by modifying the frequency responses of RIS elements in the RIS panel 1206 over time. As described below, a particular implementation may omit some or all illustrated features, and may not require some illustrated features to implement all embodiments. In some examples, a scheduling entity 900 illustrated in FIG. 9 may include a base station, a monitoring UE for sidelink communication, or any other suitable node to carry out the process 1200. In some examples, any suitable apparatus or means for carrying out the functions or algorithm described below may carry out the process 1200.

At block 1212, the RIS controller 1204 may transmit a filtering capability indication to the scheduling entity 1202 for indicating support of the RIS panel for employing an adaptive filtering function. The RIS controller 1204 may further inform the scheduling entity 1202 of the filtering capability of the RIS panel 1206 to adapt to any time varying channel characteristics. In particular, the RIS controller 1204 may inform that when the RIS controller 1204 receives one or more filtering parameters, the RIS controller 1204 may filter or refine frequency responses of RIS elements of the RIS panel 1206. The transmission from the RIS controller 1204 to the scheduling entity 1202 may be via a radio resource control (RRC) message, or any other suitable message. At block 1222, the scheduling entity 1202 may receive (e.g., via the transceiver 910) the filtering capability indication.

At block 1224, the scheduling entity 1202 may transmit, to the RIS controller 1204, a filtering enabling indication for enabling an adaptive filtering function of the RIS panel, or for modifying a mode of the adaptive filtering function of the RIS panel 1206. In some examples, the scheduling entity 1202 may enable the filtering for a suitable time (e.g., for a predetermined time). The transmission from the scheduling entity 1202 to the RIS controller 1204 may be via a radio resource control (RRC) message, a downlink control information (DCI) message, or any other suitable message. At block 1214, the RIS controller 1204 may receive (e.g., via the transceiver 1010) the filtering enabling indication.

At block 1226, the scheduling entity 1202 may estimate a channel between the scheduling entity 1202 and the scheduled entity via the RIS panel 1206 in a cascaded way. Based on the channel estimation, the scheduling entity 1202 may know a location of the scheduled entity, channel state information, and/or any other suitable information for the scheduling entity 1202 to control the RIS panel 1206 to redirect a signal from the scheduling entity 1202 to the scheduled entity. Based on the channel estimation, the scheduling entity 1202 may have knowledge about how and where to transmit a signal to the scheduled entity.

At block 1228, the scheduling entity 1202 may determine RIS control information of RIS elements of the RIS panel 1206 based on the default RIS frequency response and/or the channel estimation to modify the frequency response of the RIS panel 1206. The RIS control information may include one or more filtering parameters. The modification of the frequency response of the RIS panel 1206 may be possible by applying the one or more filtering parameters to the default RIS frequency response. The one or more filtering parameters may shift the phase and/or scale the amplitude of the frequency response of the RIS panel for an impinging signal on the RIS panel 1206 to be redirected to the scheduled entity. The one or more filtering parameters may correspond to a set of the RIS operating frequency ranges and/or one or more RIS elements of a plurality of RIS elements in the RIS panel 1206. That is, the one or more filtering parameters may vary per frequency range and/or per one or more RIS elements of the plurality of RIS elements of the RIS panel 1206

At block 1230, the scheduling entity 1202 may transmit the one or more filtering parameters to the RIS controller 1204. Blocks 1226, 1228, and 1230 may be repeated when the scheduling entity 1202 receives updated channel estimation, or for any other suitable event. In some examples, block 1232 may include the feature(s) described above in connection with block 1224, e.g., by transmitting the filtering enabling indication. That is, the scheduling entity 1202 may transmit the one or more filtering parameters along with a filtering enabling indication to the RIS controller 1204.

At block 1216, the RIS controller 1204 may receive (e.g., via the transceiver 1010) the one or more filtering parameters.

At block 1218, the RIS controller 1206 may determine one or more filtering coefficients based on the received filtering parameter(s). For example, in some aspects of this disclosure, the RIS controller 1204 may modify a frequency response of the RIS panel according to any suitable equation or calculation, including but not limited to a linear function of the RIS panel frequency response. In some examples, the filtering may be expressed as: ϕ^{t}=f^{t-1} ϕ^{t-1}+f^{t-2}ϕ^{t-2}+ . . . +f^{t-n}ϕ^{t-n}+f⁰ϕ⁰ as a linear function where ϕ may be the modified frequency response of the RIS panel 802, f^{t-n} may be a filtering coefficient, and ϕ⁰ may be the default frequency response of the RIS panel 802. The RIS controller 804 may determine the one or more filtering coefficients (f^{t-1} . . . f^{t-n}, and f⁰) based on the received one or more filtering parameters. The one or more filtering coefficients may be any function of the received parameter, frequency, and/or element of the RIS panel 802.

As one example, the RIS controller may determine a set of one or more filtering coefficients by applying the one or more filtering coefficients to the default frequency response of the RIS panel and/or a previous filtered frequency responses of the RIS panel. In some examples, the filtering may be expressed as: ϕ^{t}=αA+(1−α)ϕ^{t-1}, where α is the one or more filtering parameters, α and (1−α) are filtering coefficients, ϕ^{t} is a refined or filtered frequency response matrix of A or ϕ⁰ at time t, and ϕ^{t-1} is a previous filtered frequency response matrix of A or ϕ⁰ at time t−1. Based on the one or more filtering parameters (α), the RIS controller 1204 may determine filtering coefficients, a and 1−α. The RIS controller 1204 may apply the one or more filtering coefficients to one or more filtering characteristics which may include one or more frequency responses of the RIS for refining the one or more filtering characteristics. The application may include applying the one or more filtering coefficients to a recursive function corresponding to a history of the refined one or more filtering characteristics of the RIS panel 1206. In some examples, the RIS controller 1204 may multiply a first filtering coefficient (α) with the default frequency responses of the RIS panel (A) and multiply a second filtering coefficient (1−α) with a previous filtered frequency responses of the RIS panel (ϕ^{t-1}). The RIS controller 1204 may obtain filtered frequency responses of the RIS panel 1206 by adding these two multiplications (αA+(1−α)ϕ^{t-1}). The previous filtered frequency responses of the RIS panel (t−1) may be a function of the default frequency responses of the RIS panel (A) and the one or more filtering parameter (α) because the initial filtered frequency responses of the RIS panel (ϕ⁰) is equal to the default frequency responses of the RIS panel (A). Thus, the filtering may be expressed as:

$${ϕ}^{t} = α A + ( 1 - α ) \{ α A + ( 1 - α ) \{ … \{ α A + ( 1 - α ) A \} … \} \} .$$

The filtering coefficients may be applied to across to the entire RIS elements of the RIS panel 1206, may be a function of frequency applied to the entire RIS elements of the RIS panel 1206, or may vary per each RIS element or a group of RIS elements of the RIS panel 1206. Thus, in some examples, the RIS controller 1204 may apply the one or more filtering coefficients corresponding to a set of the one or more RIS operating frequency ranges to the one or more filtering characteristics of the RIS panel 1206 and/or apply the one or more filtering coefficients corresponding to one or more RIS elements of the plurality of RIS elements to the one or more filtering characteristics of the RIS panel 1206.

At block 1218, the RIS controller 1204 may configure the RIS 1206 based on the new filtered frequency responses of the RIS panel 1206. Blocks 1216 and1218 might be repeated when the scheduling entity 1202 transmits updated the one or more frequency responses and/or the one or more filtering coefficients or for any other suitable event.

### Further Examples Having a Variety of Features

Example 1: A method of wireless communication operable at a reconfigurable intelligent surface (RIS) controller coupled to a RIS panel, the method comprising: transmitting a RIS frequency capability indication for indicating communication support of the RIS panel for one or more frequency ranges: receiving RIS control information based on the frequency capability indication; and configuring the RIS panel based on the RIS control information.

Example 2: The method of claim 1, further comprising: transmitting a controller frequency capability indication for indicating second communication support of the RIS controller on second one or more frequency ranges, wherein the RIS control information is further based on the controller frequency capability indication.

Example 3: The method of claim 1, wherein the RIS control information comprises one or more filtering parameters corresponding to a set of frequency ranges of the one or more frequency ranges, and wherein the configuring the RIS panel comprises: configuring one or more filtering characteristics of the RIS panel as a single entity based on the corresponding one or more filtering parameters.

Example 4: The method of claim 3, wherein the one or more filtering parameters control at least one of: a phase or an amplitude of an incident signal corresponding to a filtering characteristic of the one or more filtering characteristics on the RIS panel.

Example 5: The method of claim 1, wherein the RIS panel comprises a plurality of RIS elements, wherein the RIS control information comprises one or more filtering parameters corresponding to one or more RIS elements of the plurality of RIS elements for a set of frequency ranges of the one or more frequency ranges, and wherein the configuring the RIS panel comprises: configuring one or more filtering characteristics of the one or more RIS elements based on the one or more corresponding filtering parameters.

Example 6: The method of claim 5, wherein the one or more filtering parameters corresponding to the one or more RIS elements control at least one of: one or more phases or one or more amplitudes of one or more incident signals on the one or more corresponding RIS elements.

Example 7: The method of claim 1, further comprising: transmitting a filtering capability indication for indicating support of the RIS panel for enabling an adaptive filtering function.

Example 8: The method of claim 1, further comprising: receiving a filtering capability indication for enabling an adaptive filtering function of the RIS panel, or for modifying a mode of the adaptive filtering function of the RIS panel.

Example 9: The method of claim 1, wherein the control information comprises one or more filtering parameters for a set of frequency ranges of the one or more frequency ranges, and wherein the configuring the RIS panel comprises: applying one or more filtering coefficients based on the one or more filtering parameters to one or more filtering characteristics of the RIS panel as a single entity for refining the one or more filtering characteristics of the RIS panel.

Example 10: The method of claim 9, wherein the configuring the one or more filtering characteristics of the RIS panel comprises: applying the one or more filtering coefficients to a recursive function corresponding to a history of the refined one or more filtering characteristics of the RIS panel.

Example 11: The method of claim 1, wherein the RIS panel comprises a plurality of RIS elements, wherein the RIS control information comprises one or more filtering parameters corresponding to one or more RIS elements of the plurality of RIS elements for a set of frequency ranges of the one or more frequency ranges, wherein the configuring the RIS panel comprises: applying one or more filtering coefficients based on the one or more filtering parameters to one or more filtering characteristics of the RIS panel for refining the one or more filtering characteristics of the RIS panel, and wherein the one or more filtering coefficients correspond to the one or more RIS elements of the plurality of RIS elements.

Example 12: The method of claim 11, wherein the configuring the one or more filtering characteristics of the RIS panel comprises: applying the one or more filtering coefficients to a recursive function corresponding to a history of the refined one or more filtering characteristics of the RIS panel.

Example 13: A non-transitory computer-readable medium storing computer-executable code, comprising code for causing a reconfigurable intelligent surface (RIS) controller coupled to a RIS panel to: transmit a RIS frequency capability indication for indicating communication support of the RIS panel for one or more frequency ranges; receive RIS control information based on the frequency capability indication; and configure the RIS panel based on the RIS control information.

Example 14: The non-transitory computer-readable medium of claim 13, wherein the RIS panel comprises a plurality of RIS elements, wherein the RIS control information comprises one or more filtering parameters corresponding to one or more RIS elements of the plurality of RIS elements for a set of frequency ranges of the one or more frequency ranges, and wherein the configuring the RIS panel comprises: configuring one or more filtering characteristics of the one or more RIS elements based on the one or more corresponding filtering parameters.

Example 15: The non-transitory computer-readable medium of claim 14, wherein the one or more filtering parameters corresponding to the one or more RIS elements control at least one of: one or more phases or one or more amplitudes of one or more incident signals on the one or more corresponding RIS elements.

Example 16: A method of wireless communication operable at a scheduling entity, the method comprising: receiving, from a reconfigurable intelligent surface (RIS) controller, a RIS frequency capability indication for indicating communication support of a RIS panel for one or more frequency ranges; and transmitting, to the RIS controller, RIS control information based on the RIS frequency capability indication for configuring the RIS panel based on the RIS control information.

Example 17: The method of claim 16, further comprising: receiving a controller frequency capability indication for indicating second communication support of the RIS controller on second one or more frequency ranges, wherein the RIS control information is further based on the controller frequency capability indication.

Example 18: The method of claim 16, wherein the RIS control information comprises one or more filtering parameters corresponding to a set of the one or more frequency ranges, and wherein the transmitting the RIS control information is for configuring one or more filtering characteristics of the RIS panel as a single entity based on the corresponding one or more filtering parameters.

Example 19: The method of claim 18, wherein the one or more filtering parameters control at least one of: a phase or an amplitude of an incident signal corresponding to a filtering characteristic of the one or more filtering characteristics on the RIS panel.

Example 20: The method of claim 16, wherein the RIS panel comprises a plurality of RIS elements, wherein the RIS control information comprises one or more filtering parameters corresponding to one or more RIS elements of the plurality of RIS elements for a set of frequency ranges of the one or more frequency ranges, and wherein the transmitting the RIS control information is for configuring one or more filtering characteristics of the one or more RIS elements based on the one or more corresponding filtering parameters.

Example 21: The method of claim 20, wherein the one or more filtering parameters corresponding to the one or more RIS elements control at least one of: one or more phases or one or more amplitudes of one or more incident signals on the one or more corresponding RIS elements.

Example 22: The method of claim 16, further comprising: receiving, from the RIS controller, a filtering capability indication for indicating support of the RIS panel for enabling an adaptive filtering function.

Example 23: The method of claim 16, further comprising: transmitting, to the RIS controller, a filtering capability indication for enabling an adaptive filtering function of the RIS panel, or for modifying a mode of the adaptive filtering function of the RIS panel.

Example 24: The method of claim 16, wherein the control information comprises one or more filtering parameters for a set of frequency ranges of the one or more frequency ranges, and wherein the transmitting the RIS control information is for applying one or more filtering coefficients based on the one or more filtering parameters to one or more filtering characteristics of the RIS panel as a single entity for refining the one or more filtering characteristics of the RIS panel.

Example 25: The method of claim 24, wherein the applying the one or more filtering coefficients comprises: applying the one or more filtering coefficients to a recursive function corresponding to a history of the refined one or more filtering characteristics of the RIS panel.

Example 26: The method of claim 16, wherein the RIS panel comprises a plurality of RIS elements, wherein the RIS control information comprises one or more filtering parameters corresponding to one or more RIS elements of the plurality of RIS elements for a set of frequency ranges of the one or more frequency ranges, wherein the configuring the RIS panel comprises: applying one or more filtering coefficients based on the one or more filtering parameters to one or more filtering characteristics of the RIS panel for refining the one or more filtering characteristics of the RIS panel, and wherein the one or more filtering coefficients correspond to the one or more RIS elements of the plurality of RIS elements.

Example 27: The method of claim 26, wherein the applying the one or more filtering coefficients comprises: applying the one or more filtering coefficients to a recursive function corresponding to a history of the refined one or more filtering characteristics of the RIS panel.

Example 28: A non-transitory computer-readable medium storing computer-executable code, comprising code for causing a scheduling entity to: receive, from a reconfigurable intelligent surface (RIS) controller, a RIS frequency capability indication for indicating communication support of a RIS panel for one or more frequency ranges; determine RIS control information based on the RIS frequency capability indication; and transmit, to the RIS controller, the RIS control information for configuring the RIS panel based on the RIS control information.

Example 29: The non-transitory computer-readable medium of claim 28, wherein the RIS panel comprises a plurality of RIS elements, wherein the RIS control information comprises one or more filtering parameters corresponding to one or more RIS elements of the plurality of RIS elements for a set of frequency ranges of the one or more frequency ranges, and wherein the configuring the RIS panel comprises: configuring one or more filtering characteristics of the one or more RIS elements based on the one or more corresponding filtering parameters.

Example 30: The non-transitory computer-readable medium of claim 29, wherein the one or more filtering parameters corresponding to the one or more RIS elements control at least one of: one or more phases or one or more amplitudes of one or more incident signals on the one or more corresponding RIS elements.

This disclosure presents several aspects of a wireless communication network with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the term “coupled” to refer to a direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-11 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-11 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication operable at a reconfigurable intelligent surface (RIS) controller coupled to a RIS panel, the method comprising:
transmitting a RIS frequency capability indication for indicating communication support of the RIS panel for one or more frequency ranges;
receiving RIS control information based on the frequency capability indication; and
configuring the RIS panel based on the RIS control information.

2. The method of claim 1, further comprising:
transmitting a controller frequency capability indication for indicating second communication support of the RIS controller on second one or more frequency ranges,
wherein the RIS control information is further based on the controller frequency capability indication.

3. The method of claim 1, wherein the RIS control information comprises one or more filtering parameters corresponding to a set of frequency ranges of the one or more frequency ranges, and
wherein the configuring the RIS panel comprises: configuring one or more filtering characteristics of the RIS panel as a single entity based on the corresponding one or more filtering parameters.

4. The method of claim 3, wherein the one or more filtering parameters control at least one of: a phase or an amplitude of an incident signal corresponding to a filtering characteristic of the one or more filtering characteristics on the RIS panel.

5. The method of claim 1, wherein the RIS panel comprises a plurality of RIS elements,
wherein the RIS control information comprises one or more filtering parameters corresponding to one or more RIS elements of the plurality of RIS elements for a set of frequency ranges of the one or more frequency ranges, and
wherein the configuring the RIS panel comprises: configuring one or more filtering characteristics of the one or more RIS elements based on the one or more corresponding filtering parameters.

6. The method of claim 5, wherein the one or more filtering parameters corresponding to the one or more RIS elements control at least one of: one or more phases or one or more amplitudes of one or more incident signals on the one or more corresponding RIS elements.

7. The method of claim 1, further comprising:
transmitting a filtering capability indication for indicating support of the RIS panel for enabling an adaptive filtering function.

8. The method of claim 1, further comprising:
receiving a filtering capability indication for enabling an adaptive filtering function of the RIS panel, or for modifying a mode of the adaptive filtering function of the RIS panel.

9. The method of claim 1, wherein the control information comprises one or more filtering parameters for a set of frequency ranges of the one or more frequency ranges, and
wherein the configuring the RIS panel comprises: applying one or more filtering coefficients based on the one or more filtering parameters to one or more filtering characteristics of the RIS panel as a single entity for refining the one or more filtering characteristics of the RIS panel.

10. The method of claim 9, wherein the configuring the one or more filtering characteristics of the RIS panel comprises:
applying the one or more filtering coefficients to a recursive function corresponding to a history of the refined one or more filtering characteristics of the RIS panel.

11. The method of claim 1, wherein the RIS panel comprises a plurality of RIS elements,
wherein the RIS control information comprises one or more filtering parameters corresponding to one or more RIS elements of the plurality of RIS elements for a set of frequency ranges of the one or more frequency ranges,
wherein the configuring the RIS panel comprises: applying one or more filtering coefficients based on the one or more filtering parameters to one or more filtering characteristics of the RIS panel for refining the one or more filtering characteristics of the RIS panel, and
wherein the one or more filtering coefficients correspond to the one or more RIS elements of the plurality of RIS elements.

12. The method of claim 11, wherein the configuring the one or more filtering characteristics of the RIS panel comprises:
applying the one or more filtering coefficients to a recursive function corresponding to a history of the refined one or more filtering characteristics of the RIS panel.

13. A non-transitory computer-readable medium storing computer-executable code, comprising code for causing a reconfigurable intelligent surface (RIS) controller coupled to a RIS panel to:
transmit a RIS frequency capability indication for indicating communication support of the RIS panel for one or more frequency ranges;
receive RIS control information based on the frequency capability indication; and
configure the RIS panel based on the RIS control information.

14. The non-transitory computer-readable medium of claim 13, wherein the RIS panel comprises a plurality of RIS elements,
wherein the RIS control information comprises one or more filtering parameters corresponding to one or more RIS elements of the plurality of RIS elements for a set of frequency ranges of the one or more frequency ranges, and
wherein the configuring the RIS panel comprises: configuring one or more filtering characteristics of the one or more RIS elements based on the one or more corresponding filtering parameters.

15. The non-transitory computer-readable medium of claim 14, wherein the one or more filtering parameters corresponding to the one or more RIS elements control at least one of: one or more phases or one or more amplitudes of one or more incident signals on the one or more corresponding RIS elements.

16. A method of wireless communication operable at a scheduling entity, the method comprising:
receiving, from a reconfigurable intelligent surface (RIS) controller, a RIS frequency capability indication for indicating communication support of a RIS panel for one or more frequency ranges; and
transmitting, to the RIS controller, RIS control information based on the RIS frequency capability indication for configuring the RIS panel based on the RIS control information.

17. The method of claim 16, further comprising:
receiving a controller frequency capability indication for indicating second communication support of the RIS controller on second one or more frequency ranges,
wherein the RIS control information is further based on the controller frequency capability indication.

18. The method of claim 16, wherein the RIS control information comprises one or more filtering parameters corresponding to a set of the one or more frequency ranges, and
wherein the transmitting the RIS control information is for configuring one or more filtering characteristics of the RIS panel as a single entity based on the corresponding one or more filtering parameters.

19. The method of claim 18, wherein the one or more filtering parameters control at least one of: a phase or an amplitude of an incident signal corresponding to a filtering characteristic of the one or more filtering characteristics on the RIS panel.

20. The method of claim 16, wherein the RIS panel comprises a plurality of RIS elements,
wherein the RIS control information comprises one or more filtering parameters corresponding to one or more RIS elements of the plurality of RIS elements for a set of frequency ranges of the one or more frequency ranges, and
wherein the transmitting the RIS control information is for configuring one or more filtering characteristics of the one or more RIS elements based on the one or more corresponding filtering parameters.

21. The method of claim 20, wherein the one or more filtering parameters corresponding to the one or more RIS elements control at least one of: one or more phases or one or more amplitudes of one or more incident signals on the one or more corresponding RIS elements.

22. The method of claim 16, further comprising:
receiving, from the RIS controller, a filtering capability indication for indicating support of the RIS panel for enabling an adaptive filtering function.

23. The method of claim 16, further comprising:
transmitting, to the RIS controller, a filtering capability indication for enabling an adaptive filtering function of the RIS panel, or for modifying a mode of the adaptive filtering function of the RIS panel.

24. The method of claim 16, wherein the control information comprises one or more filtering parameters for a set of frequency ranges of the one or more frequency ranges, and
wherein the transmitting the RIS control information is for applying one or more filtering coefficients based on the one or more filtering parameters to one or more filtering characteristics of the RIS panel as a single entity for refining the one or more filtering characteristics of the RIS panel.

25. The method of claim 24, wherein the applying the one or more filtering coefficients comprises: applying the one or more filtering coefficients to a recursive function corresponding to a history of the refined one or more filtering characteristics of the RIS panel.

26. The method of claim 16, wherein the RIS panel comprises a plurality of RIS elements,
wherein the RIS control information comprises one or more filtering parameters corresponding to one or more RIS elements of the plurality of RIS elements for a set of frequency ranges of the one or more frequency ranges,
wherein the configuring the RIS panel comprises: applying one or more filtering coefficients based on the one or more filtering parameters to one or more filtering characteristics of the RIS panel for refining the one or more filtering characteristics of the RIS panel, and
wherein the one or more filtering coefficients correspond to the one or more RIS elements of the plurality of RIS elements.

27. The method of claim 26, wherein the applying the one or more filtering coefficients comprises:
applying the one or more filtering coefficients to a recursive function corresponding to a history of the refined one or more filtering characteristics of the RIS panel.

28. A non-transitory computer-readable medium storing computer-executable code, comprising code for causing a scheduling entity to:
receive, from a reconfigurable intelligent surface (RIS) controller, a RIS frequency capability indication for indicating communication support of a RIS panel for one or more frequency ranges;
determine RIS control information based on the RIS frequency capability indication; and
transmit, to the RIS controller, the RIS control information for configuring the RIS panel based on the RIS control information.

29. The non-transitory computer-readable medium of claim 28, wherein the RIS panel comprises a plurality of RIS elements,
wherein the RIS control information comprises one or more filtering parameters corresponding to one or more RIS elements of the plurality of RIS elements for a set of frequency ranges of the one or more frequency ranges, and
wherein the configuring the RIS panel comprises: configuring one or more filtering characteristics of the one or more RIS elements based on the one or more corresponding filtering parameters.

30. The non-transitory computer-readable medium of claim 29, wherein the one or more filtering parameters corresponding to the one or more RIS elements control at least one of: one or more phases or one or more amplitudes of one or more incident signals on the one or more corresponding RIS elements.
